(19) United States
(12) Patent Application Publication
(10) Pub. No.: US 2016/0016813 A1
(43) Pub. Date: Jan. 21, 2016

(54) OXIDE LAYER AND PRODUCTION METHOD FOR OXIDE LAYER, AS WELL AS CAPACITOR, SEMICONDUCTOR DEVICE, AND MICROELECTROMECHANICAL SYSTEM PROVIDED WITH OXIDE LAYER

(71) Applicant: JAPAN SCIENCE AND TECHNOLOGY AGENCY, Kawaguchi-shi (JP)

(72) Inventors: Tatsuya SHIMODA, Ishikawa (JP); Eisuke TOKUMITSU, Ishikawa (JP); Masatoshi ONOUE, Evanston, IL (US); Takaaki MIYASAKO, Mie (JP)

(21) Appl. No.: 14/773,309

(22) PCT Filed: Jan. 6, 2014
(86) PCT No.: PCT/JP2014/050006

§ 371 Date: Sep. 4, 2015

(30) Foreign Application Priority Data
Mar. 8, 2013 (JP) 2013-046550

(51) Int. Cl. C01G 33/00; H01B 1/08

(52) U.S. Cl. CPC C01G 33/006; H01B 1/08; C01P 2006/40; C01P 2002/36

(57) ABSTRACT

An oxide layer 30 according to the invention consists of bismuth (Bi) and niobium (Nb) (possibly including inevitable impurities). The oxide layer 30 also includes crystal phases of a pyrochlore crystal structure. The obtained oxide layer 30 includes oxide consisting of bismuth (Bi) and niobium (Nb) and has high permittivity that has never been achieved in the conventional technique.

### TECHNICAL FIELD

The present invention relates to an oxide layer, a method of producing the same, and a capacitor, a semiconductor device, and a microelectromechanical system including the same.

### BACKGROUND ART

There has been conventionally developed an oxide layer including various functional compositions. A device including a ferroelectric thin film that possibly enables high speed operation is developed as an exemplary solid-state electronic device including the oxide layer. There has been also developed BiNbO₄ as a dielectric material for a solid-state electronic device, for an oxide layer that does not contain Pb and can be baked at a relatively low temperature. There is a report on dielectric properties of such BiNbO₄ formed in accordance with the solid phase epitaxy (Non-Patent Document 1).

There has been also developed a thin film capacitor exemplifying a solid-state electronic device and including a ferroelectric thin film that possibly enables high speed operation. Metal oxide as a dielectric material for a capacitor has been formed mainly in accordance with the sputtering technique (Patent Document 1).

### PRIOR ART DOCUMENTS

### Patent Document

Patent Document 1: Japanese Patent Laid-open Publication No. 10-173140 NON-PATENT DOCUMENT
Non-Patent Document 1: Effect of phase transition on the microwave dielectric properties of BiNbO4, Eung Soo Kim, Woong Choi, Journal of the European Ceramic Society 26 (2006) 1761-1766

### SUMMARY OF THE INVENTION

### Problems to be Solved by the Invention

An insulator made of BiNbO₄ formed in accordance with the solid phase epitaxy has comparatively small relative permittivity. In order to widely adopt the insulator as a constituent element of a solid-state electronic device (e.g. a capacitor, a semiconductor device, or a microelectromechanical system), dielectric properties need to be further improved, inclusive of relative permittivity of an oxide layer or an oxide film (hereinafter, collectively called an “oxide layer” in this application).

The industry also strongly requires such oxide to be produced in accordance with an excellent production method from the industrial or mass productivity perspectives.

However, it is typically required to bring the inside of a film forming chamber into a high vacuum state in order to achieve fine properties (e.g. electrical properties or stability) of an oxide layer in the sputtering technique. The vacuum process or the photolithography technique other than the sputtering technique also typically requires relatively long time and/or expensive equipment. These processes lead to quite low utilization ratios of raw materials and production energy. When one of the above production methods is adopted, production of an oxide layer and a solid-state electronic device including the oxide layer requires many steps and long time, which is not preferred from the industrial or mass productivity perspectives. The conventional technique also causes the problem that increase in area is relatively difficult to achieve.

In view of the above, one of important technical objects for improvement in performance of an oxide layer and a solid-state electronic device including the oxide layer is to find oxide that has various properties, such as electrical properties, applicable to a solid-state electronic device and achieves various preferred properties through an excellent production method from the industrial or mass productivity perspectives.

The present invention solves the problems mentioned above, to significantly contribute to achievement of an oxide film having high dielectric properties (e.g. high relative permittivity) as well as simplification and energy saving in a process of producing such an oxide film.

### Solutions to the Problems

The inventors of this application have gone through intensive researches on oxide of high performance, which can be included in a solid-state electronic device such as a capacitor or a thin film capacitor as well as can be formed even in accordance with an inexpensive and simple method. The inventors have found, through many trials and tests, that a specific oxide material replacing conventionally and widely adopted oxide includes a crystal phase having a novel crystal structure. The inventors have also reliably found that the crystal phase enables the specific oxide material to achieve relative permittivity much higher than the conventionally known level.

The inventors of this application have further found that a method of producing the oxide layer performed not necessarily in a high vacuum state achieves inexpensive and simple production steps. The inventors have also found that the oxide layer can be patterned in accordance with an inexpensive and simple method adopting the “imprinting” technique also called “nanoimprinting”. The inventors have thus found that it is possible to obtain oxide of high performance as well as form a layer of the oxide and produce a solid-state electronic device including such oxide layers in accordance with a process that achieves remarkable simplification or energy saving as well as facilitates increase in area in comparison to the conventional technique. The present invention has been devised in view of these points. In this application, “imprinting” is occasionally called “nanoimprinting”.

An oxide layer according to the present invention consists of bismuth (Bi) and niobium (Nb) (possibly including inevitable impurities). The oxide layer also includes a crystal phase of a pyrochlore crystal structure.

Because the oxide layer includes the crystal phase of the pyrochlore crystal structure, the oxide layer achieves higher relative permittivity than that of a conventional oxide layer. Particularly, the inventors of this application analyzed to clarify that, even if this oxide layer includes a crystal phase other than the crystal phase of the pyrochlore crystal structure and the entire oxide layer thus has not very high relative permittivity, the crystal phase of the pyrochlore crystal structure is significantly higher in relative permittivity than a conventional crystal phase. The oxide layer consisting of bismuth (Bi) and niobium (Nb) and having the crystal phase of the pyrochlore crystal structure thus improves electrical properties of various solid-state electronic devices. Any mechanism or any reason why a layer of oxide consisting of bismuth (Bi) and niobium (Nb) (hereinafter, also called “BNO oxide”) achieves the pyrochlore crystal structure has not yet been clarified at the present stage. It is, however, noted that this interesting extraordinary feature achieves the dielectric properties that have never been obtained before.

A method of producing an oxide layer according to the present invention includes the step of heating, in an atmosphere containing oxygen, a precursor layer obtained from a precursor solution as a start material including both a precursor containing bismuth (Bi) and a precursor containing niobium (Nb) as solutes, at a temperature of 520° C. or more and less than 600° C., to form the oxide layer including crystal phases of a pyrochlore crystal structure and consisting of bismuth (Bi) and niobium (Nb) (possibly including inevitable impurities).

The method of producing the oxide layer includes the step of forming an oxide layer that consists of bismuth (Bi) and niobium (Nb) and has the crystal phase of the pyrochlore crystal structure (possibly including inevitable impurities). The oxide layer produced in accordance with this production method thus has higher relative permittivity than that of a conventional oxide layer. Particularly, the inventors of this application analyzed to clarify that, even if this oxide layer includes a crystal phase other than the crystal phase of the pyrochlore crystal structure and the entire oxide layer thus has not very high relative permittivity, the crystal phase of the pyrochlore crystal structure is significantly higher in relative permittivity than a conventional crystal phase. The oxide layer consisting of bismuth (Bi) and niobium (Nb) and having the crystal phase of the pyrochlore crystal structure thus improves electrical properties of various solid-state electronic devices. Any mechanism or any reason why the BNO oxide layer achieves the pyrochlore crystal structure has not yet been clarified at the present stage. It is, however, noted that this interesting extraordinary feature achieves the dielectric properties that have never been obtained before.

According to the method of producing the oxide layer, the oxide layer can be formed through a relatively simple process not in accordance with the photolithography technique (but in accordance with the ink jet technique, the screen printing technique, the intaglio/relief printing technique, the nanoimprinting technique, or the like). There is thus no need to include a process requiring relatively long time and/or expensive equipment, such as the vacuum process. This method of producing the oxide layer is accordingly excellent from the industrial or mass productivity perspectives.

### Effects of the Invention

An oxide layer according to the present invention has relative permittivity higher than that of a conventional oxide layer and thus achieves improvement in electrical properties of various solid-state electronic devices.

A method of producing an oxide layer according to the present invention enables production of an oxide layer having higher relative permittivity than that of a conventional oxide layer. This method of producing the oxide layer is also excellent from the industrial or mass productivity perspectives.

### BRIEF DESCRIPTION OF THE DRAWINGS

FIG. 1 is a view of an entire configuration of a thin film capacitor exemplifying a solid-state electronic device according to a first embodiment of the present invention.

FIG. 2 is a sectional schematic view of a process in a method of producing the thin film capacitor according to the first embodiment of the present invention.

FIG. 3 is a sectional schematic view of a process in the method of producing the thin film capacitor according to the first embodiment of the present invention.

FIG. 4 is a sectional schematic view of a process in the method of producing the thin film capacitor according to the first embodiment of the present invention.

FIG. 5 is a sectional schematic view of a process in the method of producing the thin film capacitor according to the first embodiment of the present invention.

FIG. 6 is a sectional schematic view of a process in a method of producing a thin film capacitor according to a second embodiment of the present invention.

FIG. 7 is a sectional schematic view of a process in the method of producing the thin film capacitor according to the second embodiment of the present invention.

FIG. 8 is a sectional schematic view of a process in the method of producing the thin film capacitor according to the second embodiment of the present invention.

FIG. 9 is a sectional schematic view of a process in the method of producing the thin film capacitor according to the second embodiment of the present invention.

FIG. 10 is a view of an entire configuration of the thin film capacitor exemplifying a solid-state electronic device according to the second embodiment of the present invention.

FIG. 11 is a view of an entire configuration of a thin film capacitor exemplifying a solid-state electronic device according to a third embodiment of the present invention.

FIG. 12 is a sectional schematic view of a process in a method of producing the thin film capacitor according to the third embodiment of the present invention.

FIG. 13 is a sectional schematic view of a process in the method of producing the thin film capacitor according to the third embodiment of the present invention.

FIG. 14 is a sectional schematic view of a process in the method of producing the thin film capacitor according to the third embodiment of the present invention.

FIG. 15 is a sectional schematic view of a process in the method of producing the thin film capacitor according to the third embodiment of the present invention.

FIG. 16 is a sectional schematic view of a process in the method of producing the thin film capacitor according to the third embodiment of the present invention.

FIG. 17 is a sectional schematic view of a process in the method of producing the thin film capacitor according to the third embodiment of the present invention.

FIG. 18 is a sectional schematic view of a process in the method of producing the thin film capacitor according to the third embodiment of the present invention.

FIG. 19 is a sectional schematic view of a process in the method of producing the thin film capacitor according to the third embodiment of the present invention.

FIG. 20 is a sectional schematic view of a process in the method of producing the thin film capacitor according to the third embodiment of the present invention.

FIG. 21 is a sectional schematic view of a process in the method of producing the thin film capacitor according to the third embodiment of the present invention.

FIG. 22 is a sectional schematic view of a process in a method of producing a thin film capacitor according to a fourth embodiment of the present invention.

FIG. 23 is a sectional schematic view of a process in the method of producing the thin film capacitor according to the fourth embodiment of the present invention.

FIG. 24 is a sectional schematic view of a process in the method of producing the thin film capacitor according to the fourth embodiment of the present invention.

FIG. 25 is a view of an entire configuration of the thin film capacitor exemplifying a solid-state electronic device according to the fourth embodiment of the present invention.

FIGS. 26(a) and 26(b) are a cross-sectional TEM picture and an electron beam diffraction image each showing a crystal structure of an oxide layer serving as an insulating layer in the first embodiment of the present invention.

FIGS. 27(a) and 27(b) are a cross-sectional TEM picture and an electron beam diffraction image each showing a crystal structure of an oxide layer serving as an insulating layer in a comparative example 5 (the sputtering technique).

FIGS. 28(a) and 28(b) are a TOPO image (by a scanning probe microscope (in a supersensitive SNDM mode)) and a varied capacity image of each crystal phase in a plan view, of an oxide layer serving as an insulating layer in an example 6.

FIGS. 29(a) and 29(b) are a TOPO image (by a scanning probe microscope (in a supersensitive SNDM mode)) and a varied capacity image of each crystal phase in a plan view, of the oxide layer serving as an insulating layer in the comparative example 5 (the sputtering technique).

FIGS. 30(a) and 30(b) are relative permittivity images indicating distribution of calibrated relative permittivity from varied capacity images of each crystal phase in a plan view of the oxide layer serving as an insulating layer in the comparative example 5 (the sputtering technique) and the oxide layer serving as an insulating layer in the example 6.

### EMBODIMENTS OF THE INVENTION

A solid-state electronic device according to each of the embodiments of the present invention will now be described in detail with reference to the accompanying drawings. In this disclosure, common parts are denoted by common reference signs in all the drawings unless otherwise specified. Furthermore, components according to these embodiments are not necessarily illustrated in accordance with relative scaling in the drawings. Moreover, some of the reference signs may not be indicated for the purpose of easier recognition of the respective drawings.

### First Embodiment

### 1. Entire Configuration of Thin Film Capacitor According to the Present Embodiment

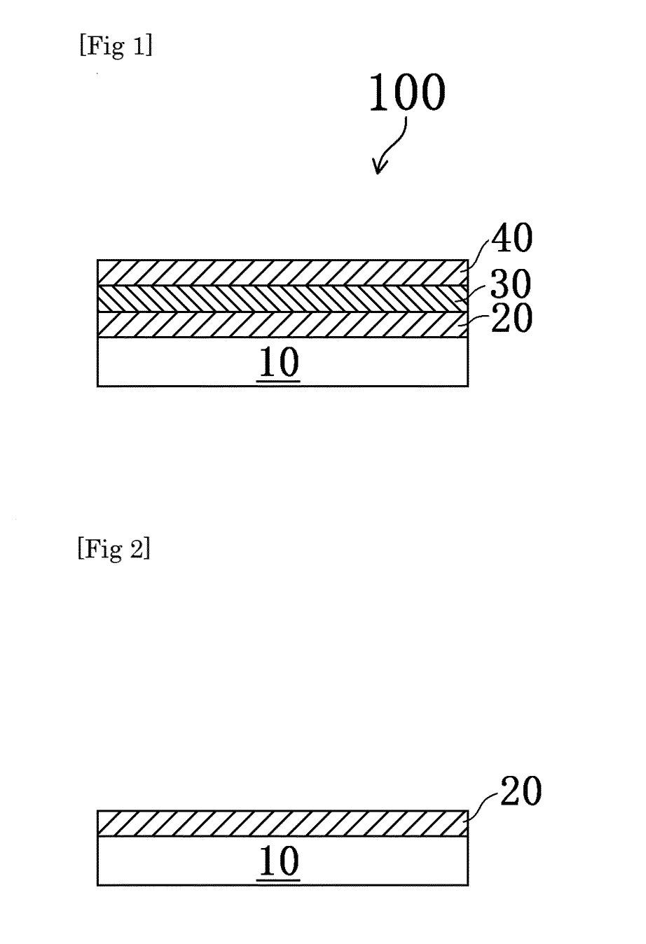

FIG. 1 is a view of an entire configuration of a thin film capacitor 100 exemplifying a solid-state electronic device according to the present embodiment. As shown in FIG. 1, the thin film capacitor 100 includes a substrate 10, a lower electrode layer 20, an oxide layer 30 serving as an insulating layer made of a dielectric substance, and an upper electrode layer 40. The lower electrode layer 20, the oxide layer 30, and the upper electrode layer 40 are stacked on the substrate 10 in this order.

The substrate 10 can be made of any one of various insulating base materials including highly heat resistant glass, an SiO₂/Si substrate, an alumina (Al₂O₃) substrate, an STO (SrTiO) substrate, an insulating substrate obtained by forming an STO (SrTiO) layer on a surface of an Si substrate with an SiO₂ layer and a Ti layer being interposed therebetween, and a semiconductor substrate (e.g. an Si substrate, an SiC substrate, or a Ge substrate).

The lower electrode layer 20 and the upper electrode layer 40 are each made of any one of metallic materials including high melting metal such as platinum, gold, silver, copper, aluminum, molybdenum, palladium, ruthenium, iridium, or tungsten, alloy thereof, and the like.

In the present embodiment, the insulating layer made of a dielectric substance is formed by heating, in an atmosphere containing oxygen, a precursor layer obtained from a precursor solution as a start material including both a precursor containing bismuth (Bi) and a precursor containing niobium (Nb) as solutes (hereinafter, a production method including this step is also called the solution technique). There is thus formed the oxide layer 30 consisting of bismuth (Bi) and niobium (Nb) (possibly including inevitable impurities; this applies hereinafter). Furthermore, as to be described later, the present embodiment is characterized in that a heating temperature (a main baking temperature) for forming the oxide layer is set in the range from 520° C. or more to less than 600° C. (more preferably, 580° C. or less). The oxide layer consisting of bismuth (Bi) and niobium (Nb) is also called a BNO layer.

The present embodiment is not limited to this structure. Moreover, patterning of an extraction electrode layer from each electrode layer is not illustrated in order to simplify the drawings.

### 2. Method of Producing Thin Film Capacitor 100

Described next is a method of producing the thin film capacitor 100. Temperatures indicated in this application are preset temperatures of a heater. FIGS. 2 to 5 are sectional schematic views each showing a process in the method of producing the thin film capacitor 100. As shown in FIG. 2, the lower electrode layer 20 is initially formed on the substrate 10. The oxide layer 30 is then formed on the lower electrode layer 20, and the upper electrode layer 40 is subsequently formed on the oxide layer 30.

### (1) Formation of Lower Electrode Layer

FIG. 2 shows the step of forming the lower electrode layer 20. The present embodiment exemplifies a case where the lower electrode layer 20 in the thin film capacitor 100 is made of platinum (Pt). The lower electrode layer 20 made of platinum (Pt) is formed on the substrate 10 in accordance with the known sputtering technique.

### (2) Formation of Oxide Layer Serving as Insulating Layer

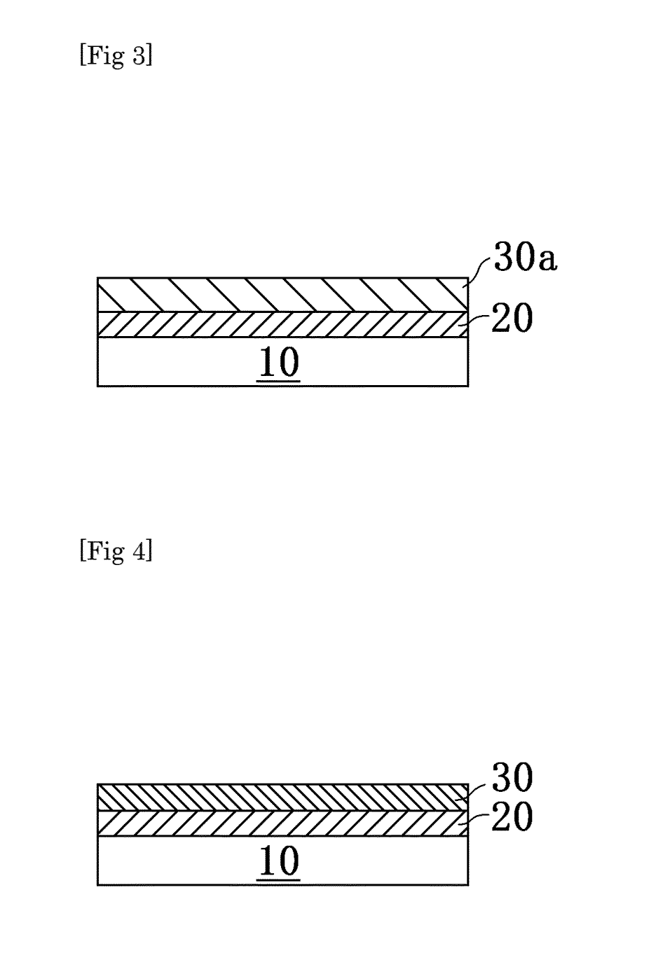

The oxide layer 30 is then formed on the lower electrode layer 20. The oxide layer 30 is formed through (a) the step of forming and preliminarily baking the precursor layer and then (b) the main baking step. FIGS. 3 and 4 each show the step of forming the oxide layer 30. The present embodiment exemplifies a case where the oxide layer 30 is formed using oxide consisting of bismuth (Bi) and niobium (Nb) in the steps of producing the thin film capacitor 100.

### (a) Formation and Preliminary Baking of Precursor Layer

As shown in FIG. 3, formed on the lower electrode layer 20 in accordance with the known spin coating technique is a precursor layer 30a obtained from a precursor solution as a start material including both a precursor containing bismuth (Bi) and a precursor containing niobium (Nb) as solutes (called a precursor solution; hereinafter, this applies to a solution of a precursor). Examples of the precursor containing bismuth (Bi) for the oxide layer 30 possibly include bismuth octylate, bismuth chloride, bismuth nitrate, and any bismuth alkoxide (e.g. bismuth isopropoxide, bismuth butoxide, bismuth ethoxide, or bismuth methoxyethoxide). Examples of the precursor containing niobium (Nb) for the oxide layer 30 in the present embodiment possibly include niobium octylate, niobium chloride, niobium nitrate, and any niobium alkoxide (e.g. niobium isopropoxide, niobium butoxide, niobium ethoxide, or niobium methoxyethoxide). The precursor solution preferably includes a solvent of one alcohol selected from the group consisting of ethanol, propanol, butanol, 2-methoxyethanol, 2-ethoxyethanol, and 2-butoxyethanol, or a solvent of one carboxylic acid selected from the group consisting of acetic acid, propionic acid, and octylic acid.

The preliminary baking is then performed in the oxygen atmosphere or in the atmosphere (collectively called an “atmosphere containing oxygen”) for a predetermined time period at a temperature in the range from 80° C. or more to 250° C. or less. The preliminary baking sufficiently evaporates the solvent in the precursor layer 30a and causes a preferred gel state for exerting properties that enable future plastic deformation (possibly a state where organic chains remain before pyrolysis). The preliminary baking is performed preferably at a temperature of 80° C. or more and 250° C. or less in order to reliably cause the above phenomena. The formation of the precursor layer 30a in accordance with the spin coating technique and the preliminary baking are repeated for a plurality of times, so that the oxide layer 30 has desired thickness.

### (b) Main Baking

The precursor layer 30a is thereafter heated for a predetermined time period in the oxygen atmosphere (e.g. 100% by volume, although being not limited thereto) at a temperature in the range from 520° C. or more to less than 600° C. (more preferably, 580° C. or less) so as to be mainly baked. As shown in FIG. 4, there is thus formed the oxide layer 30 consisting of bismuth (Bi) and niobium (Nb) on the electrode layer. The main baking in accordance with the solution technique is performed in order to form the oxide layer at a heating temperature of 520° C. or more and less than 600° C. (more preferably, 580° C. or less), although this upper limit is not fixed to such a degree. The heating temperature exceeding 600° C. stimulates crystallization of the oxide layer and tends to cause remarkable increase in amount of leakage current. The heating temperature is thus preferably set to be less than 600° C. (more preferably, 580° C. or less). The heating temperature less than 520° C. causes carbon in the solvent and the solute in the precursor solution to remain and causes remarkable increase in amount of leakage current. In view of the above, the heating temperature is thus preferably set to the range from 520° C. or more to less than 600° C. (more preferably, 580° C. or less).

The oxide layer 30 is preferably 30 nm or more in thickness. If the oxide layer 30 is less than 30 nm in thickness, the leakage current and dielectric loss increase due to decrease in thickness. It is impractical and thus not preferred for a solid-state electronic device to include such an oxide layer.

Table 1 indicates measurement results on the relationship among the atomic composition ratio between bismuth (Bi) and niobium (Nb) in the oxide layer 30, relative permittivity at 1 KHz, and a leakage current value upon applying 0.5 MV/cm.

TABLE 1

| | Relative permittivity | Leakage current (A/cm²) |
|---|---|---|
| Nb/Bi ratio | (1 KHz) | (0.5 MV/cm) |
| 3.3 | 62 | 1.4 × 10⁻⁶ |
| 2.0 | 134 | 2.5 × 10⁻⁴ |
| 1.1 | 201 | 5.8 × 10⁻⁶ |
| 0.8 | 137 | 4.2 × 10⁻⁶ |

The atomic composition ratio between bismuth (Bi) and niobium (Nb) was obtained by performing elementary analysis on bismuth (Bi) and niobium (Nb) in accordance with the Rutherford backscattering spectrometry (RBS). The methods of measuring the relative permittivity and the leakage current value are to be detailed later. Table 1 indicates the results of the relative permittivity upon applying the AC voltage of 1 KHz and the leakage current value upon applying the voltage of 0.5 MV/cm. According to Table 1, when the atomic composition ratio between bismuth (Bi) and niobium (Nb) in the oxide layer 30 is in the range from 0.8 or more to 3.3 or less relative to bismuth (Bi) assumed to be one, the relative permittivity and the leakage current value were found to be particularly preferably appropriate for various solid-state electronic devices (e.g. a capacitor, a semiconductor device, or a microelectromechanical system).

### (3) Formation of Upper Electrode Layer

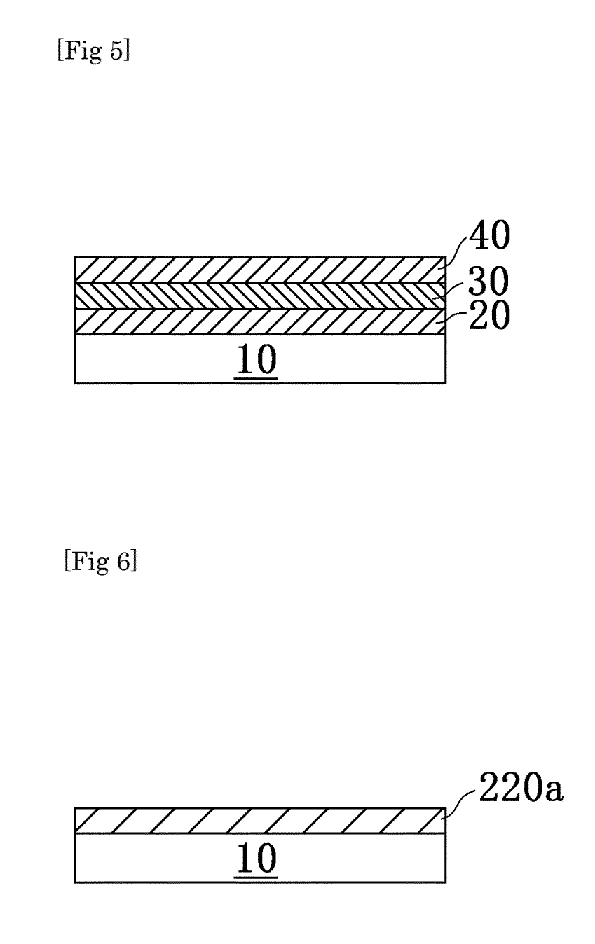

The upper electrode layer 40 is subsequently formed on the oxide layer 30. FIG. 5 shows the step of forming the upper electrode layer 40. The present embodiment exemplifies a case where the upper electrode layer 40 in the thin film capacitor 100 is made of platinum (Pt). Similarly to the lower electrode layer 20, the upper electrode layer 40 made of platinum (Pt) is formed on the oxide layer 30 in accordance with the known sputtering technique.

According to the present embodiment, the oxide layer consisting of bismuth (Bi) and niobium (Nb) is formed by heating, in an atmosphere containing oxygen, the precursor layer obtained from the precursor solution as a start material including both the precursor containing bismuth (Bi) and the precursor containing niobium (Nb) as solutes. When the oxide layer is formed at a heating temperature of 520° C. or more and less than 600° C. (more preferably, 580° C. or less), the oxide layer achieves particularly preferred electrical properties. Furthermore, in the method of producing the oxide layer according to the present embodiment, the precursor solution for the oxide layer has only to be heated in an atmosphere containing oxygen without adopting the vacuum process. Accordingly, increase in area is facilitated and improvement from the industrial or mass productivity perspectives can be significantly achieved in comparison to the conventional sputtering technique.

### Second Embodiment

### 1. Entire Configuration of Thin Film Capacitor According to the Present Embodiment

A thin film capacitor exemplifying a solid-state electronic device according to the present embodiment includes a lower electrode layer and an upper electrode layer each of which is made of conductive oxide (possibly including inevitable impurities; this applies hereinafter) such as metal oxide. FIG. 10 shows an entire configuration of a thin film capacitor 200 exemplifying the solid-state electronic device according to the present embodiment. The present embodiment is similar to the first embodiment except that the lower electrode layer and the upper electrode layer are each made of conductive oxide such as metal oxide. Accordingly, the configurations similar to those of the first embodiment will not be described repeatedly.

As shown in FIG. 10, the thin film capacitor 200 according to the present embodiment includes the substrate 10. The thin film capacitor 200 is further provided, on the substrate 10, with a lower electrode layer 220, the oxide layer 30 serving as an insulating layer made of a dielectric substance, and an upper electrode layer 240. The lower electrode layer 220, the oxide layer 30, and the upper electrode layer 240 are stacked on the substrate 10 in this order.

Examples of the lower electrode layer 220 and the upper electrode layer 240 can include an oxide layer consisting of lanthanum (La) and nickel (Ni), an oxide layer consisting of antimony (Sb) and tin (Sn), and an oxide layer consisting of indium (In) and tin (Sn) (possibly including inevitable impurities; this applies hereinafter).

### 2. Steps of Producing Thin Film Capacitor 200

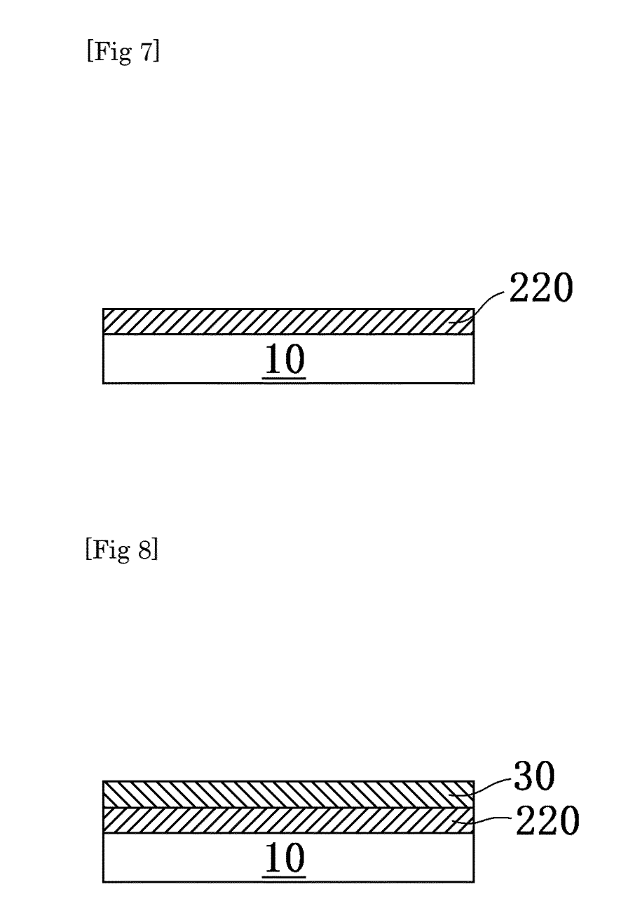

Described next is a method of producing the thin film capacitor 200. FIGS. 6 to 9 are sectional schematic views each showing a process in the method of producing the thin film capacitor 200. As shown in FIGS. 6 and 7, the lower electrode layer 220 is initially formed on the substrate 10. The oxide layer 30 is then formed on the lower electrode layer 220, and the upper electrode layer 240 is subsequently formed. Also in the steps of producing the thin film capacitor 200, those similar to the steps according to the first embodiment will not be described repeatedly.

### (1) Formation of Lower Electrode Layer

FIGS. 6 and 7 each show the step of forming the lower electrode layer 220. The present embodiment exemplifies a case where the lower electrode layer 220 in the thin film capacitor 200 is a conducting oxide layer consisting of lanthanum (La) and nickel (Ni). The lower electrode layer 220 is formed through (a) the step of forming and preliminarily baking the precursor layer and then (b) the main baking step.

### (a) Formation and Preliminary Baking of Precursor Layer

As shown in FIG. 6, formed on the substrate 10 in accordance with the known spin coating technique is a lower electrode layer precursor layer 220a obtained from a precursor solution as a start material including both a precursor containing lanthanum (La) and a precursor containing nickel (Ni) as solutes (called a lower electrode layer precursor solution; hereinafter, this applies to a solution of a lower electrode layer precursor). Examples of the precursor containing lanthanum (La) for the lower electrode layer 220 include lanthanum acetate. The examples also possibly include lanthanum nitrate, lanthanum chloride, and any lanthanum alkoxide (e.g. lanthanum isopropoxide, lanthanum butoxide, lanthanum ethoxide, or lanthanum methoxyethoxide). Examples of the precursor containing nickel (Ni) for the lower electrode layer precursor layer 220a include nickel acetate. The examples also possibly include nickel nitrate, nickel chloride, and any nickel alkoxide (e.g. nickel indium isopropoxide, nickel butoxide, nickel ethoxide, or nickel methoxyethoxide).

When the lower electrode layer is a conducting oxide layer consisting of antimony (Sb) and tin (Sn), examples of a lower electrode layer precursor containing antimony (Sb) possibly include antimony acetate, antimony nitrate, antimony chloride, and any antimony alkoxide (e.g. antimony isopropoxide, antimony butoxide, antimony ethoxide, or antimony methoxyethoxide). Examples of a precursor containing tin (Sn) possibly include tin acetate, tin nitrate, tin chloride, and any tin alkoxide (e.g. antimony isopropoxide, antimony butoxide, antimony ethoxide, or antimony methoxyethoxide). When the lower electrode layer is made of conducting oxide consisting of indium (In) and tin (Sn), examples of a precursor containing indium (In) possibly include indium acetate, indium nitrate, indium chloride, and any indium alkoxide (e.g. indium isopropoxide, indium butoxide, indium ethoxide, or indium methoxyethoxide). Examples of a lower electrode layer precursor containing tin (Sn) are similar to those listed above.

The preliminary baking is then performed in an atmosphere containing oxygen for a predetermined time period at a temperature in the range from 80° C. or more to 250° C. or less, for the same reason on the oxide layer according to the first embodiment. The formation of the lower electrode layer precursor layer 220a in accordance with the spin coating technique and the preliminary baking are repeated for a plurality of times, so that the lower electrode layer 220 has desired thickness.

### (b) Main Baking

The lower electrode layer precursor layer 220a is then heated to 550° C. for about 20 minutes in the oxygen atmosphere so as to be mainly baked. As shown in FIG. 7, there is thus formed, on the substrate 10, the lower electrode layer 220 consisting of lanthanum (La) and nickel (Ni) (possibly including inevitable impurities; this applies hereinafter). The main baking in accordance with the solution technique is performed in order to form the conducting oxide layer preferably at a heating temperature of 520° C. or more and less than 600° C. (more preferably, 580° C. or less), for the same reason on the oxide layer according to the first embodiment. The conducting oxide layer made of lanthanum (La) and nickel (Ni) is also called an LNO layer.

### (2) Formation of Oxide Layer Serving as Insulating Layer

The oxide layer 30 is subsequently formed on the lower electrode layer 220. Similarly to the first embodiment, the oxide layer 30 according to the present embodiment is formed through (a) the step of forming and preliminarily baking the precursor layer and then (b) the main baking step. FIG. 8 shows the state where the oxide layer 30 is formed on the lower electrode layer 220. Similarly to the first embodiment, the oxide layer 30 is preferably 30 nm or more in thickness.

### (3) Formation of Upper Electrode Layer

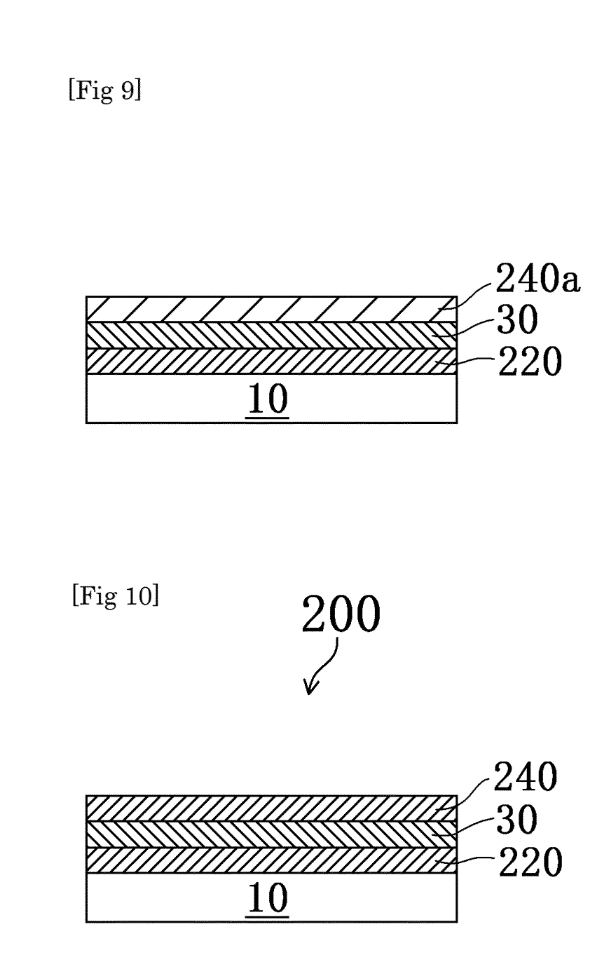

As shown in FIGS. 9 and 10, the upper electrode layer 240 is subsequently formed on the oxide layer 30. The present embodiment exemplifies a case where the upper electrode layer 240 in the thin film capacitor 200 is a conducting oxide layer consisting of lanthanum (La) and nickel (Ni), similarly to the lower electrode layer 220. Similarly to the lower electrode layer 220, the upper electrode layer 240 is formed through (a) the step of forming and preliminarily baking the precursor layer and then (b) the main baking step. FIG. 9 shows a lower electrode layer precursor layer 240a formed on the oxide layer 30. FIG. 10 shows the upper electrode layer 240 formed on the oxide layer 30.

According to the present embodiment, the oxide layer consisting of bismuth (Bi) and niobium (Nb) is formed by heating, in an atmosphere containing oxygen, the precursor layer obtained from the precursor solution as a start material including both the precursor containing bismuth (Bi) and the precursor containing niobium (Nb) as solutes. When the oxide layer is formed at a heating temperature of 520° C. or more and less than 600° C. (more preferably, 580° C. or less), the oxide layer achieves particularly preferred electrical properties. Furthermore, in the method of producing the oxide layer according to the present embodiment, the precursor solution for the oxide layer has only to be heated in an atmosphere containing oxygen without adopting the vacuum process. This production method thus achieves improvement from the industrial or mass productivity perspectives. Furthermore, the lower electrode layer, the oxide layer serving as an insulating layer, and the upper electrode layer are each made of metal oxide and all the steps can be executed in an atmosphere containing oxygen without adopting the vacuum process. Accordingly, increase in area is facilitated and improvement from the industrial or mass productivity perspectives can be significantly achieved in comparison to the conventional sputtering technique.

### Third Embodiment

### 1. Entire Configuration of Thin Film Capacitor According to the Present Embodiment

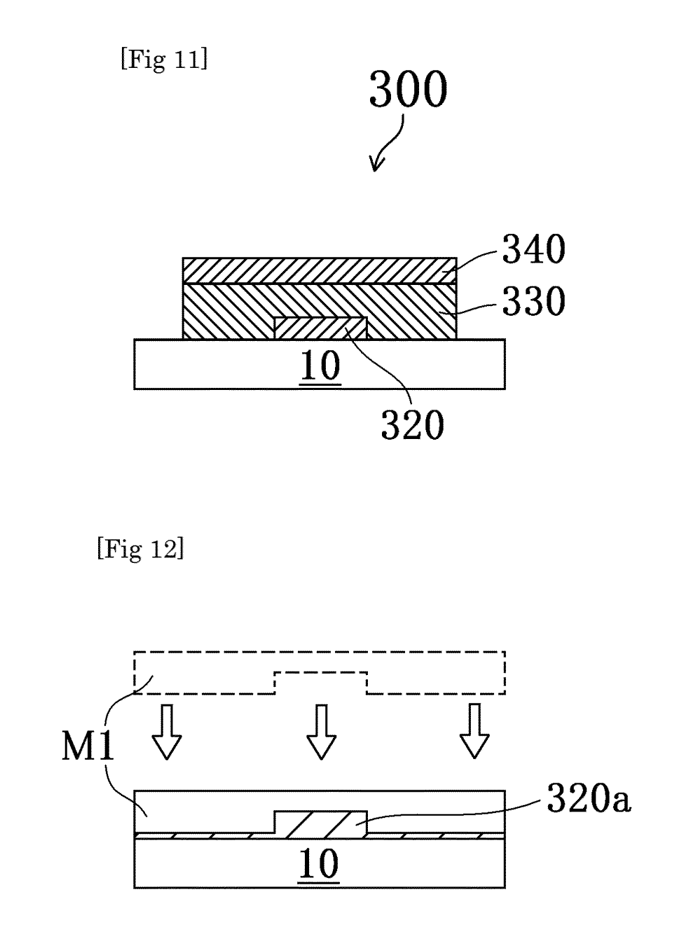

Imprinting is performed in the step of forming every one of the layers in a thin film capacitor exemplifying a solid-state electronic device according to the present embodiment. FIG. 11 shows an entire configuration of a thin film capacitor 300 exemplifying the solid-state electronic device according to the present embodiment. The present embodiment is similar to the second embodiment except that the lower electrode layer and the oxide layer are imprinted. Accordingly, the configurations similar to those of the first or second embodiment will not be described repeatedly.

As shown in FIG. 11, the thin film capacitor 300 according to the present embodiment includes the substrate 10. The thin film capacitor 300 is further provided, on the substrate 10, with a lower electrode layer 320, an oxide layer 330 serving as an insulating layer made of a dielectric substance, and an upper electrode layer 340. The lower electrode layer 320, the oxide layer 330, and the upper electrode layer 340 are stacked on the substrate 10 in this order.

### 2. Steps of Producing Thin Film Capacitor 300

A method of producing the thin film capacitor 300 will be described next. FIGS. 12 to 21 are sectional schematic views each showing a process in the method of producing the thin film capacitor 300. Production of the thin film capacitor 300 includes initial formation, on the substrate 10, of the imprinted lower electrode layer 320. The imprinted oxide layer 330 is subsequently formed on the lower electrode layer 320. The upper electrode layer 340 is then formed on the oxide layer 330. Also in the steps of producing the thin film capacitor 300, those similar to the steps according to the first or second embodiment will not be described repeatedly.

### (1) Formation of Lower Electrode Layer

The present embodiment exemplifies a case where the lower electrode layer 320 in the thin film capacitor 300 is a conducting oxide layer consisting of lanthanum (La) and nickel (Ni). The lower electrode layer 320 is formed through (a) the step of forming and preliminarily baking the precursor layer, (b) the imprinting step, and (c) the main baking step, in this order. Initially formed on the substrate 10 in accordance with the known spin coating technique is a lower electrode layer precursor layer 320a obtained from a lower electrode layer precursor solution as a start material including both a precursor containing lanthanum (La) and a precursor containing nickel (Ni) as solutes.

The lower electrode layer precursor layer 320a is then heated in an atmosphere containing oxygen for a predetermined time period at a temperature in the range from 80° C. or more to 250° C. or less so as to be preliminarily baked. The formation of the lower electrode layer precursor layer 320a in accordance with the spin coating technique and the preliminary baking are repeated for a plurality of times, so that the lower electrode layer 320 has desired thickness.

### (b) Imprinting

As shown in FIG. 12, the imprinting is subsequently performed using a lower electrode layer mold M1 with a pressure of 1 MPa or more and 20 MPa or less while the lower electrode layer precursor layer 320a is heated at a temperature in the range from 80° C. or more to 300° C. or less so as to pattern the lower electrode layer precursor layer 320a. Examples of a heating method for the imprinting include a method of causing an atmosphere at a predetermined temperature using a chamber, an oven, or the like, a method of heating a base provided thereon with the substrate from below using a heater, and a method of imprinting using a mold preliminarily heated to a temperature of 80° C. or more and 300° C. or less. In view of processability, the imprinting is more preferably performed in accordance with the method of heating a base from below using a heater, as well as using a mold preliminarily heated to a temperature of 80° C. or more and 300° C. or less.

The mold heating temperature is set in the range from 80° C. or more to 300° C. or less for the following reasons. If the heating temperature for the imprinting is less than 80° C., the temperature of the lower electrode layer precursor layer 320a is decreased so that plastic deformability of the lower electrode layer precursor layer 320a deteriorates. This leads to lower moldability during formation of an imprinted structure, or lower reliability or stability after the formation. In contrast, if the heating temperature for the imprinting exceeds 300° C., decomposition of organic chains (oxidative pyrolysis) exerting plastic deformability proceeds and the plastic deformability thus deteriorates. In view of the above, according to a more preferred aspect, the lower electrode layer precursor layer 320a is heated at a temperature in the range from 100° C. or more to 250° C. or less for the imprinting.

The imprinting can be performed with a pressure in the range from 1 MPa or more to 20 MPa or less so that the lower electrode layer precursor layer 320a is deformed so as to follow the shape of the surface of the mold. It is thus possible to highly accurately form a desired imprinted structure. The pressure to be applied for the imprinting is set in such a low range from 1 MPa or more to 20 MPa or less. In this case, the mold is unlikely to be damaged during the imprinting and increase in area can be also achieved advantageously.

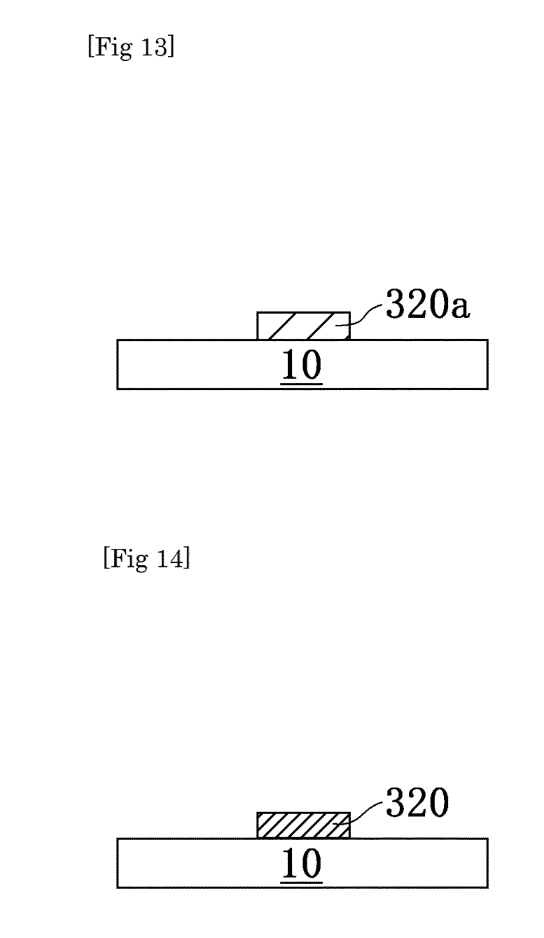

The lower electrode layer precursor layer 320a is then entirely etched. As shown in FIG. 13, the lower electrode layer precursor layer 320a is thus entirely removed in the regions other than a region corresponding to the lower electrode layer (the step of entirely etching the lower electrode layer precursor layer 320a).

In this imprinting, preferably, a mold separation process is preliminarily performed on the surface of each of the precursor layers to be in contact with an imprinting surface and/or on the imprinting surface of the mold, and each of the precursor layers is then imprinted. Such a process is performed. Frictional force between each of the precursor layers and the mold can be thus decreased, so that the precursor layer can be imprinted with higher accuracy. Examples of a mold separation agent applicable in the mold separation process include surface active agents (e.g. a fluorochemical surface active agent, a silicon surface active agent, and a non-ionic surface active agent), and diamond-like carbon containing fluorine.

### (c) Main Baking

The lower electrode layer precursor layer 320a is subsequently mainly baked. As shown in FIG. 14, there is thus formed, on the substrate 10, the lower electrode layer 320 consisting of lanthanum (La) and nickel (Ni) (possibly including inevitable impurities; this applies hereinafter).

### (2) Formation of Oxide Layer Serving as Insulating Layer

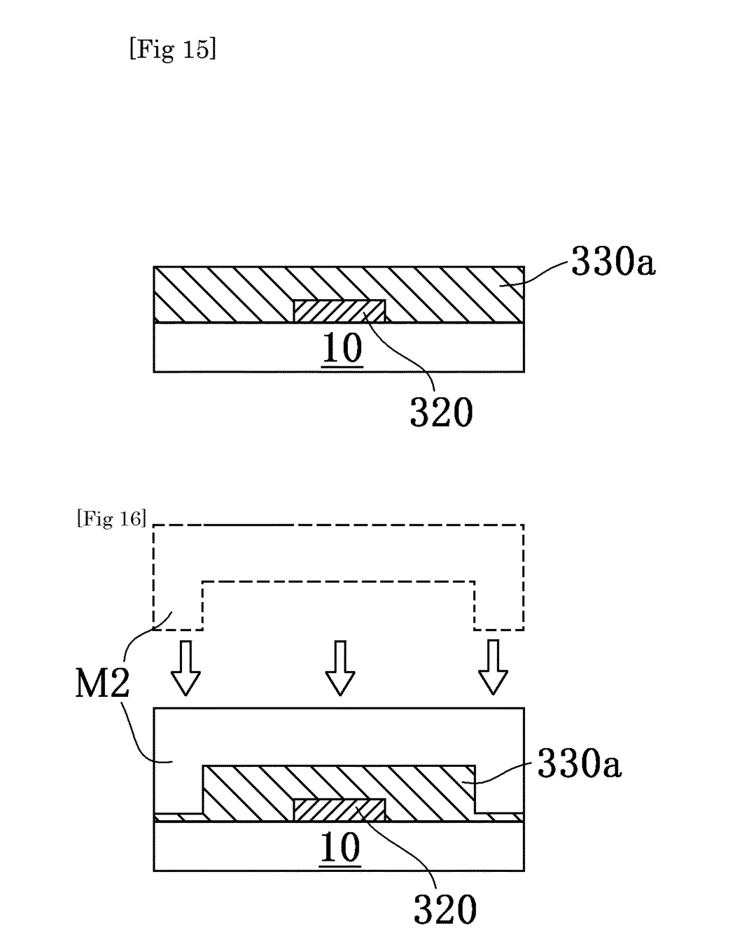

The oxide layer 330 serving as an insulating layer is subsequently formed on the lower electrode layer 320. The oxide layer 330 is formed through (a) the step of forming and preliminarily baking the precursor layer, (b) the imprinting step, and (c) the main baking step, in this order. FIGS. 15 to 18 each show the step of forming the oxide layer 330.

### (a) Formation and Preliminary Baking of Precursor Layer

As shown in FIG. 15, similarly to the second embodiment, formed on the substrate 10 and the patterned lower electrode layer 320 is a precursor layer 330a obtained from a precursor solution as a start material including both a precursor containing bismuth (Bi) and a precursor containing niobium (Nb) as solutes. The precursor layer 330a is then preliminarily baked in an atmosphere containing oxygen in the state where the precursor layer 330a is heated to a temperature of 80° C. or more and 250° C. or less.

### (b) Imprinting

As shown in FIG. 16, the precursor layer 330a only preliminarily baked is imprinted in the present embodiment. Specifically, the imprinting is performed using an insulating layer mold M2 with a pressure of 1 MPa or more and 20 MPa or less in the state where the precursor layer 330a is heated to a temperature of 80° C. or more and 300° C. or less so as to pattern the oxide layer.

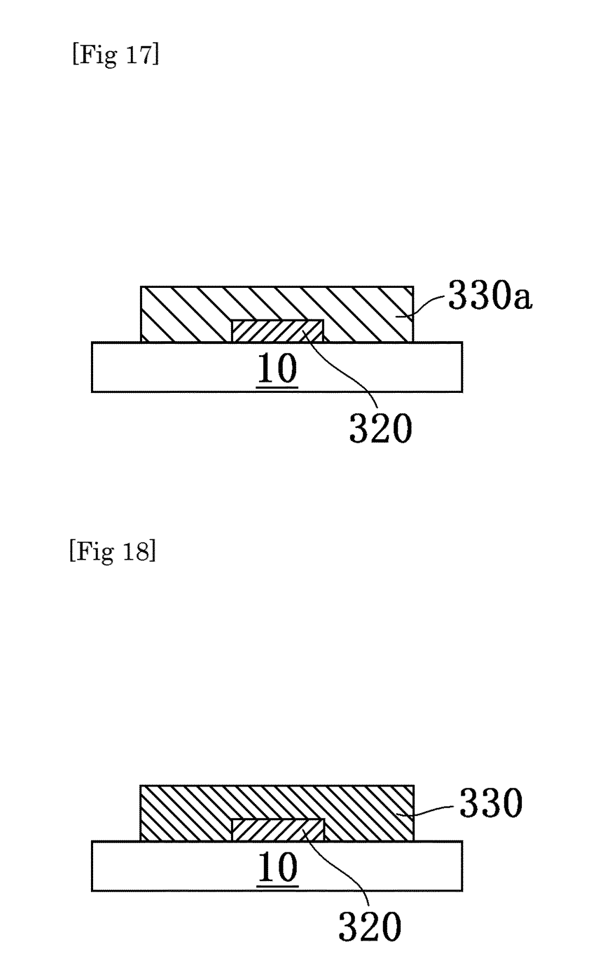

The precursor layer 330a is then entirely etched. As shown in FIG. 17, the precursor layer 330a is thus entirely removed in the regions other than a region corresponding to the oxide layer 330 (the step of entirely etching the precursor layer 330a). The step of etching the precursor layer 330a in the present embodiment is executed in accordance with the wet etching technique without adopting the vacuum process. The etching can be possibly performed using plasma, in accordance with the so-called dry etching technique.

### (c) Main Baking

Similarly to the second embodiment, the precursor layer 330a is subsequently mainly baked. As shown in FIG. 18, the oxide layer 330 serving as an insulating layer (possibly including inevitable impurities; this applies hereinafter) is thus formed on the lower electrode layer 320. The precursor layer 330a is heated in the oxygen atmosphere for a predetermined time period at a temperature in the range from 520° C. or more to less than 600° C. (more preferably, 580° C. or less) so as to be mainly baked.

The step of entirely etching the precursor layer 330a can be executed after the main baking. As described above, according to a more preferred aspect, the step of entirely etching the precursor layer is executed between the imprinting step and the main baking step. This is because the unnecessary region can be removed more easily in comparison to the case of etching each precursor layer after the main baking.

### (3) Formation of Upper Electrode Layer

Similarly to the lower electrode layer 320, subsequently formed on the oxide layer 330 in accordance with the known spin coating technique is an upper electrode layer precursor layer 340a obtained from a precursor solution as a start material including both a precursor containing lanthanum (La) and a precursor containing nickel (Ni) as solutes. The upper electrode layer precursor layer 340a is then heated in an atmosphere containing oxygen at a temperature in the range from 80° C. or more to 250° C. or less so as to be preliminarily baked.

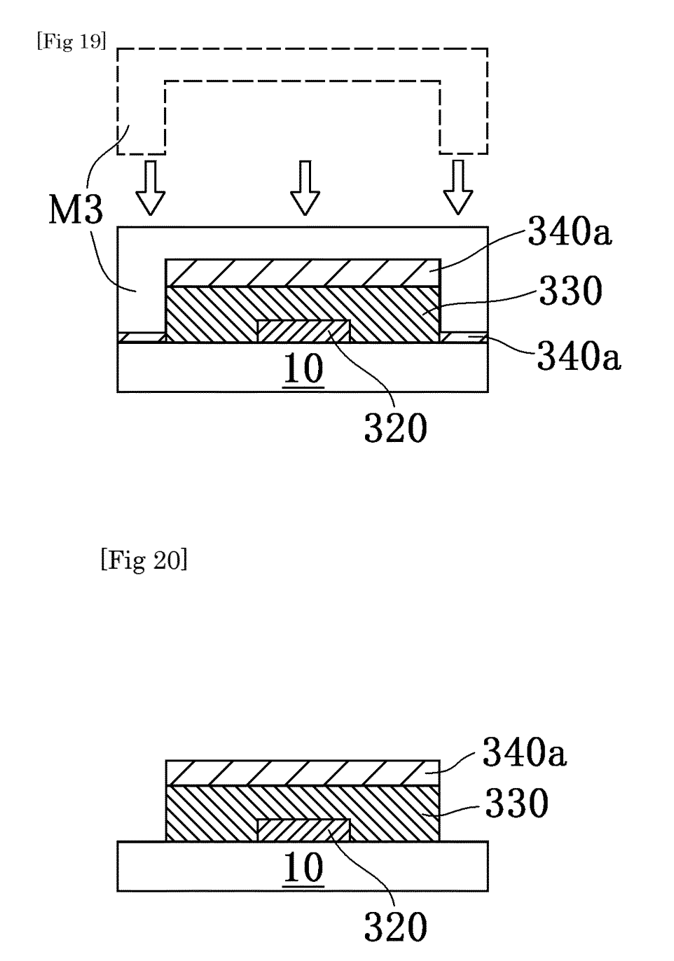

As shown in FIG. 19, the upper electrode layer precursor layer 340a having been preliminarily baked is subsequently imprinted using an upper electrode layer mold M3 with a pressure of 1 MPa or more and 20 MPa or less in the state where the upper electrode layer precursor layer 340a is heated to a temperature of 80° C. or more and 300° C. or less so as to pattern the upper electrode layer precursor layer 340a. As shown in FIG. 20, the upper electrode layer precursor layer 340a is then entirely etched so that the upper electrode layer precursor layer 340a is entirely removed in the regions other than a region corresponding to the upper electrode layer 340.

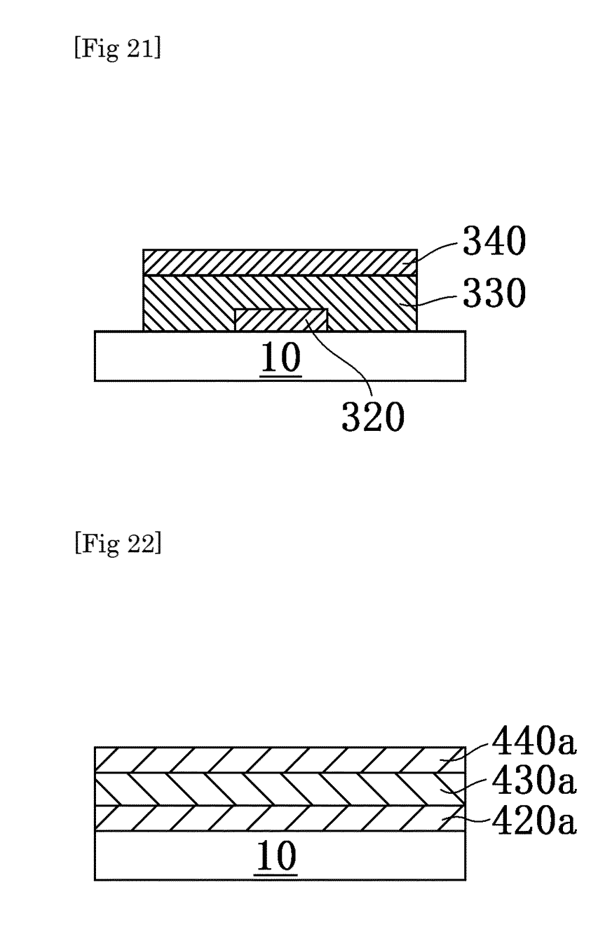

As shown in FIG. 21, the upper electrode layer precursor layer 340a is then heated in the oxygen atmosphere for a predetermined time period to a temperature of 530° C. or more and 600° C. or less so as to be mainly baked. The upper electrode layer 340 consisting of lanthanum (La) and nickel (Ni) (possibly including inevitable impurities; this applies hereinafter) is thus formed on the oxide layer 330.

Also according to the present embodiment, the oxide layer consisting of bismuth (Bi) and niobium (Nb) is formed by heating, in an atmosphere containing oxygen, the precursor layer obtained from the precursor solution as a start material including both the precursor containing bismuth (Bi) and the precursor containing niobium (Nb) as solutes. When the oxide layer is formed at a heating temperature of 520° C. or more and less than 600° C. (more preferably, 580° C. or less), the oxide layer achieves particularly preferred electrical properties. Furthermore, in the method of producing the oxide layer according to the present embodiment, the precursor solution for the oxide layer has only to be heated in an atmosphere containing oxygen without adopting the vacuum process. Accordingly, increase in area is facilitated and improvement from the industrial or mass productivity perspectives can be significantly achieved in comparison to the conventional sputtering technique.

The thin film capacitor 300 according to the present embodiment is further provided, on the substrate 10, with the lower electrode layer 320, the oxide layer 330 serving as an insulating layer, and the upper electrode layer 340. The lower electrode layer 320, the oxide layer 330, and the upper electrode layer 340 are stacked on the substrate 10 in this order. Each of these layers is imprinted to have an imprinted structure. There is thus no need to include a process requiring relatively long time and/or expensive equipment, such as the vacuum process, a process in accordance with the photolithography technique, or the ultraviolet irradiation process. The electrode layers and the oxide layer can be thus patterned easily. The thin film capacitor 300 according to the present embodiment is accordingly quite excellent from the industrial or mass productivity perspectives.

### Fourth Embodiment

### 1. Entire Configuration of Thin Film Capacitor According to the Present Embodiment

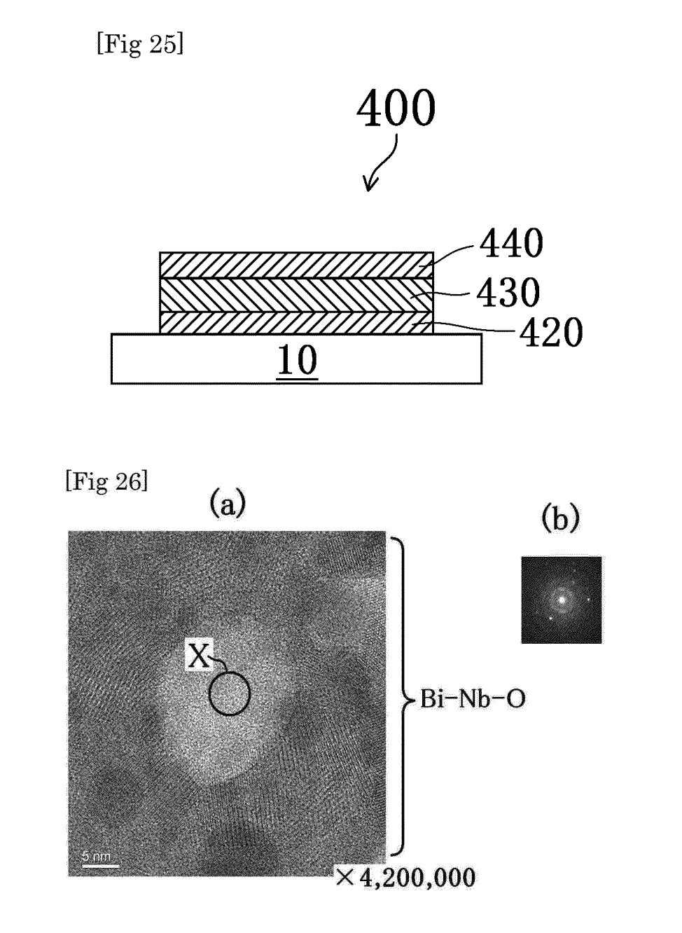

Imprinting is performed in the step of forming every one of the layers in a thin film capacitor exemplifying a solid-state electronic device also according to the present embodiment. FIG. 25 shows an entire configuration of a thin film capacitor 400 exemplifying the solid-state electronic device according to the present embodiment. Each of a lower electrode layer, an oxide layer, and an upper electrode layer according to the present embodiment is preliminarily baked after a corresponding precursor layer is stacked.

Each of the precursor layers having been preliminarily baked is imprinted and then mainly baked. The configurations of the present embodiment similar to those of the first to third embodiments will not be described repeatedly. As shown in FIG. 25, the thin film capacitor 400 includes the substrate 10. The thin film capacitor 400 is further provided, on the substrate 10, with a lower electrode layer 420, an oxide layer 430 serving as an insulating layer made of a dielectric substance, and an upper electrode layer 440. The lower electrode layer 420, the oxide layer 430, and the upper electrode layer 440 are stacked on the substrate 10 in this order.

### 2. Steps of Producing Thin Film Capacitor 400

Described next is a method of producing the thin film capacitor 400. FIGS. 22 to 24 are sectional schematic views each showing a process in the method of producing the thin film capacitor 400. In order to produce the thin film capacitor 400, initially formed on the substrate 10 is a stacked body including a lower electrode layer precursor layer 420a as a precursor layer of the lower electrode layer 420, a precursor layer 430a of the oxide layer 430, and an upper electrode layer precursor layer 440a as a precursor layer of the upper electrode layer 440. The stacked body is imprinted and is then mainly baked. Also in the steps of producing the thin film capacitor 400, those similar to the steps according to the first to third embodiments will not be described repeatedly.

### (1) Formation of Stacked Body Including Precursor Layers

As shown in FIG. 22, initially formed on the substrate 10 is the stacked body including the lower electrode layer precursor layer 420a as a precursor layer of the lower electrode layer 420, the precursor layer 430a of the oxide layer 430, and the upper electrode layer precursor layer 440a as a precursor layer of the upper electrode layer 440. Similarly to the third embodiment, the present embodiment exemplifies a case where each of the lower electrode layer 420 and the upper electrode layer 440 in the thin film capacitor 400 is a conducting oxide layer consisting of lanthanum (La) and nickel (Ni), and the oxide layer 430 serving as an insulating layer consists of bismuth (Bi) and niobium (Nb). Initially formed on the substrate 10 in accordance with the known spin coating technique is the lower electrode layer precursor layer 420a obtained from a lower electrode layer precursor solution as a start material including both a precursor containing lanthanum (La) and a precursor containing nickel (Ni) as solutes. The lower electrode layer precursor layer 420a is then heated in an atmosphere containing oxygen for a predetermined time period at a temperature in the range from 80° C. or more to 250° C. or less so as to be preliminarily baked. The formation of the lower electrode layer precursor layer 420a in accordance with the spin coating technique and the preliminary baking are repeated for a plurality of times, so that the lower electrode layer 420 has desired thickness.

The precursor layer 430a is then formed on the lower electrode layer precursor layer 420a having been preliminarily baked. Initially formed on the lower electrode layer precursor layer 420a is the precursor layer 430a obtained from a precursor solution as a start material including both a precursor containing bismuth (Bi) and a precursor containing niobium (Nb) as solutes. The precursor layer 430a is then heated in an atmosphere containing oxygen for a predetermined time period at a temperature in the range from 80° C. or more to 250° C. or less so as to be preliminarily baked.

Similarly to the lower electrode layer precursor layer 420a, subsequently formed on the preliminarily baked precursor layer 430a in accordance with the known spin coating technique is the upper electrode layer precursor layer 440a obtained from a precursor solution as a start material including both a precursor containing lanthanum (La) and a precursor containing nickel (Ni) as solutes. The upper electrode layer precursor layer 440a is then heated in an atmosphere containing oxygen at a temperature in the range from 80° C. or more to 250° C. or less so as to be preliminarily baked.

### (2) Imprinting

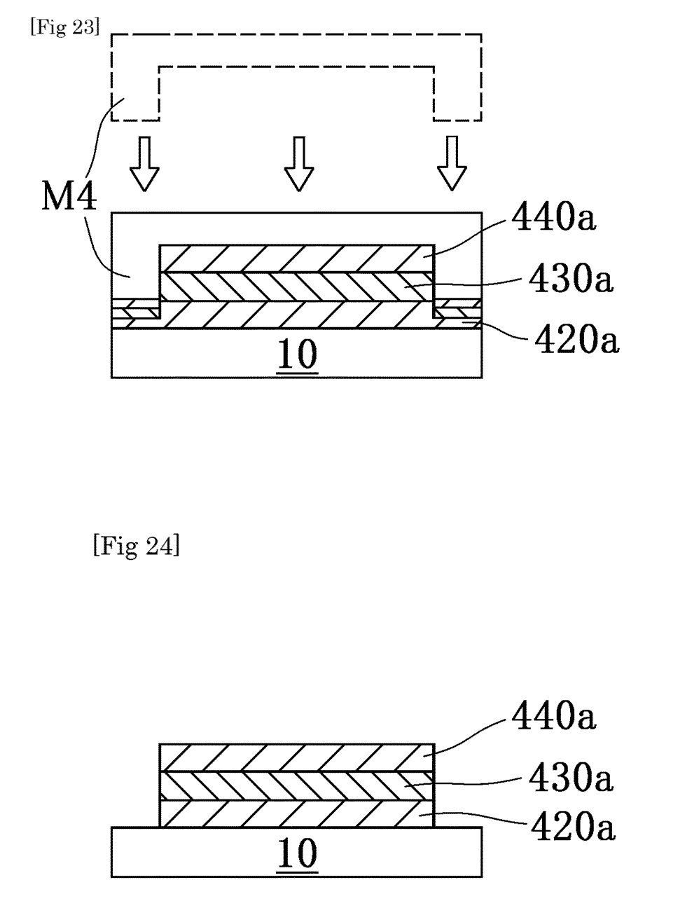

As shown in FIG. 23, the imprinting is subsequently performed using a stacked body mold M4 with a pressure of 1 MPa or more and 20 MPa or less in the state where the stacked body of the precursor layers (420a, 430a, and 440a) is heated at a temperature in the range from 80° C. or more to 300° C. or less so as to pattern the stacked body of the precursor layers (420a, 430a, and 440a).

The stacked body of the precursor layers (420a, 430a, and 440a) is then entirely etched. As shown in FIG. 24, the stacked body of the precursor layers (420a, 430a, and 440a) is thus entirely removed in the regions other than a region corresponding to the lower electrode layer, the oxide layer, and the upper electrode layer (the step of entirely etching the stacked body of the precursor layers (420a, 430a, and 440a)).

### (3) Main Baking

The stacked body of the precursor layers (420a, 430a, and 440a) is subsequently mainly baked. As shown in FIG. 25, the lower electrode layer 420, the oxide layer 430, and the upper electrode layer 440 are accordingly formed on the substrate 10.

Also according to the present embodiment, the oxide layer consisting of bismuth (Bi) and niobium (Nb) is formed by heating, in an atmosphere containing oxygen, the precursor layer obtained from the precursor solution as a start material including both the precursor containing bismuth (Bi) and the precursor containing niobium (Nb) as solutes. When the oxide layer is formed at a heating temperature of 520° C. or more and less than 600° C. (more preferably, 580° C. or less), the oxide layer achieves particularly preferred electrical properties. Furthermore, in the method of producing the oxide layer according to the present embodiment, the precursor solution for the oxide layer has only to be heated in an atmosphere containing oxygen without adopting the vacuum process. Accordingly, increase in area is facilitated and improvement from the industrial or mass productivity perspectives can be significantly achieved in comparison to the conventional sputtering technique.

In the present embodiment, all the preliminarily baked precursor layers of the oxide layers are imprinted and then mainly baked. It is thus possible to shorten the steps of forming the imprinted structure.

### EXAMPLES

Examples and comparative examples are provided to describe the present invention in more detail. The present invention is, however, not limited to these examples.

In each of the examples and comparative examples, measurement of physical properties of a solid-state electronic device and composition analysis of a BNO oxide layer were performed in the following manner.

### 1. Electrical Properties

### (1) Leakage Current

The voltage of 0.25 MV/cm was applied between the lower electrode layer and the upper electrode layer to measure current. The measurement was performed using the analyzer 4156C manufactured by Agilent Technologies, Inc.

### (2) Dielectric Loss (tan δ)

Dielectric loss in each of the examples and the comparative examples was measured in the following manner. The voltage of 0.1 V or the AC voltage of 1 KHz was applied between the lower electrode layer and the upper electrode layer at a room temperature to measure dielectric loss. The measurement was performed using the broadband permittivity measurement system 1260-SYS manufactured by TOYO Corporation.

### (3) Relative Permittivity

Relative permittivity in each of the examples and the comparative examples was measured in the following manner. The voltage of 0.1 V or the AC voltage of 1 KHz was applied between the lower electrode layer and the upper electrode layer to measure relative permittivity. The measurement was performed using the broadband permittivity measurement system 1260-SYS manufactured by TOYO Corporation.

### 2. Content Percentages of Carbon and Hydrogen in BNO Oxide Layer

Elementary analysis was performed using Pelletron 3SDH manufactured by National Electrostatics Corporation in accordance with the Rutherford backscattering spectrometry (RBS), the Hydrogen Forward scattering Spectrometry (HFS), and the Nuclear Reaction Analysis (NRA), to obtain content percentages of carbon and hydrogen in the BNO oxide layer according to each of the examples and the comparative examples.

### 3. Crystal Structure Analysis of BNO Oxide Layer by Cross-Sectional TEM Picture and Electron Beam Diffraction

The BNO oxide layer according to each of the examples and the comparative examples was observed using a cross-sectional Transmission Electron Microscopy (TEM) picture and an electron beam diffraction image. A Miller index and an interatomic distance were obtained from the electron beam diffraction image of the BNO oxide layer according to each of the examples and the comparative examples, and fitting with a known crystal structure model was performed to analyze the structure. Adopted as the known crystal structure model was (Bi_{1.5}Zn_{0.5})(Zn_{0.5}Nb_{1.5})O₇, β-BiNbO₄, or Bi₃NbO₇.

### Example 1

A thin film capacitor of the example 1 was produced in accordance with the production method of the present embodiment. A lower electrode layer is initially formed on a substrate and an oxide layer is formed subsequently. An upper electrode layer is then formed on the oxide layer. The substrate is made of highly heat resistant glass. The lower electrode layer made of platinum (Pt) was formed on the substrate in accordance with the known sputtering technique. The lower electrode layer was 200 nm thick in this case. Bismuth octylate was used as a precursor containing bismuth (Bi) and niobium octylate was used as a precursor containing niobium (Nb) for the oxide layer serving as an insulating layer. Preliminary baking was performed by heating to 250° C. for five minutes. Formation of a precursor layer in accordance with the spin coating technique and the preliminary baking were repeated for five times. The precursor layer was heated to 520° C. for about 20 minutes in the oxygen atmosphere so as to be mainly baked. The oxide layer 30 was about 170 nm thick. The thickness of each of the layers was obtained as a difference in height between each of the layers and the substrate in accordance with the tracer method. The atomic composition ratio between bismuth (Bi) assumed to be one and niobium (Nb) was 1:1 in the oxide layer. The upper electrode layer made of platinum (Pt) was formed on the oxide layer in accordance with the known sputtering technique. The upper electrode layer in this case was 100 μm×100 μm in size and 150 nm in thickness. Electrical properties exhibited the leakage current value of 3.0×10⁻⁴ A/cm², the dielectric loss of 0.025, and the relative permittivity of 62. It was also found that the BNO oxide layer has a fine crystal phase of the pyrochlore crystal structure. More specifically, the pyrochlore crystal structure was found to be either the (Bi_{1.5}Zn_{0.5})(Zn_{0.5}Nb_{1.5})O₇ structure or substantially identical with or approximate to the (Bi_{1.5}Zn_{0.5})(Zn_{0.5}Nb_{1.5})O₇ structure.

### Example 2

A thin film capacitor according to the example 2 was produced under conditions similar to those of the example 1 except that the precursor layer was heated to 520° C. for one hour in the oxygen atmosphere so as to be mainly baked. Electrical properties exhibited the leakage current value of 3.0×10⁻⁸ A/cm², the dielectric loss of 0.01, and the relative permittivity of 70. It was also found that the BNO oxide layer has a fine crystal phase of the pyrochlore crystal structure. More specifically, the pyrochlore crystal structure was found to be either the (Bi_{1.5}Zn_{0.5})(Zn_{0.5}Nb_{1.5})O₇ structure or substantially identical with or approximate to the (Bi_{1.5}Zn_{0.5})(Zn_{0.5}Nb_{1.5})O₇ structure. Furthermore, the carbon content percentage had a small value of 1.5 atm % or less, which is equal to or less than the detectable limit. The hydrogen content percentage was 1.6 atm %.

### Example 3

A thin film capacitor according to the example 3 was produced under conditions similar to those of the example 1 except that the precursor layer was heated to 530° C. for 20 minutes in the oxygen atmosphere so as to be mainly baked. Electrical properties exhibited the leakage current value of 3.0×10⁻⁶ A/cm², the dielectric loss of 0.01, and the relative permittivity of 110. It was also found that the BNO oxide layer has a fine crystal phase of the pyrochlore crystal structure. More specifically, the pyrochlore crystal structure was found to be either the (Bi_{1.5}Zn_{0.5})(Zn_{0.5}Nb_{1.5})O₇ structure or substantially identical with or approximate to the (Bi_{1.5}Zn_{0.5})(Zn_{0.5}Nb_{1.5})O₇ structure.

### Example 4

A thin film capacitor according to the example 4 was produced under conditions similar to those of the example 1 except that the precursor layer was heated to 530° C. for two hours in the oxygen atmosphere so as to be mainly baked. Electrical properties exhibited the leakage current value of 8.8×10⁻⁸ A/cm², the dielectric loss of 0.018, and the relative permittivity of 170. It was also found that the BNO oxide layer has a fine crystal phase of the pyrochlore crystal structure. More specifically, the pyrochlore crystal structure was found to be either the (Bi_{1.5}Zn_{0.5})(Zn_{0.5}Nb_{1.5})O₇ structure or substantially identical with or approximate to the (Bi_{1.5}Zn_{0.5})(Zn_{0.5}Nb_{1.5})O₇ structure. Furthermore, the carbon content percentage had a small value of 1.5 atm % or less, which is equal to or less than the detectable limit. The hydrogen content percentage was 1.4 atm %.

### Example 5

A thin film capacitor according to the example 5 was produced under conditions similar to those of the example 1 except that the precursor layer was heated to 550° C. for one minute in the oxygen atmosphere so as to be mainly baked. Electrical properties exhibited the leakage current value of 5.0×10⁻⁷ A/cm², the dielectric loss of 0.01, and the relative permittivity of 100. It was also found that the BNO oxide layer has a fine crystal phase of the pyrochlore crystal structure. More specifically, the pyrochlore crystal structure was found to be either the (Bi_{1.5}Zn_{0.5})(Zn_{0.5}Nb_{1.5})O₇ structure or substantially identical with or approximate to the (Bi_{1.5}Zn_{0.5})(Zn_{0.5}Nb_{1.5})O₇ structure.

### Example 6

A thin film capacitor according to the example 6 was produced under conditions similar to those of the example 1 except that the precursor layer was heated to 550° C. for 20 minutes in the oxygen atmosphere so as to be mainly baked. Electrical properties exhibited the leakage current value of 1.0×10⁻⁶ A/cm², the dielectric loss of 0.001, and the relative permittivity of 180. It was also found that the BNO oxide layer has a fine crystal phase of the pyrochlore crystal structure. More specifically, the pyrochlore crystal structure was found to be either the (Bi_{1.5}Zn_{0.5})(Zn_{0.5}Nb_{1.5})O₇ structure or substantially identical with or approximate to the (Bi_{1.5}Zn_{0.5})(Zn_{0.5}Nb_{1.5})O₇ structure. Furthermore, the carbon content percentage was 1.5 atm % or less and the hydrogen content percentage was 1.0 atm % or less, each of which had a small value equal to or less than the detectable limit.

### Example 7

A thin film capacitor according to the example 7 was produced under conditions similar to those of the example 1 except that the precursor layer was heated to 550° C. for 12 hours in the oxygen atmosphere so as to be mainly baked. Electrical properties exhibited the leakage current value of 2.0×10⁻⁵ A/cm², the dielectric loss of 0.004, and the relative permittivity of 100. It was also found that the BNO oxide layer has a fine crystal phase of the pyrochlore crystal structure. More specifically, the pyrochlore crystal structure was found to be either the (Bi_{1.5}Zn_{0.5})(Zn_{0.5}Nb_{1.5})O₇ structure or substantially identical with or approximate to the (Bi_{1.5}Zn_{0.5})(Zn_{0.5}Nb_{1.5})O₇ structure.

### Example 8

A thin film capacitor according to the example 8 was produced under conditions similar to those of the example 1 except that the precursor layer was heated to 580° C. for 20 minutes in the oxygen atmosphere so as to be mainly baked. Electrical properties exhibited the leakage current value of 1.0×10⁻⁶ A/cm², the dielectric loss of 0.001, and the relative permittivity of 100. It was also found that the BNO oxide layer has a fine crystal phase of the pyrochlore crystal structure. More specifically, the pyrochlore crystal structure was found to be either the (Bi_{1.5}Zn_{0.5})(Zn_{0.5}Nb_{1.5})O₇ structure or substantially identical with or approximate to the (Bi_{1.5}Zn_{0.5})(Zn_{0.5}Nb_{1.5})O₇ structure.

### Comparative Example 1

A thin film capacitor according to the comparative example 1 was produced under conditions similar to those of the example 1 except that the precursor layer was heated to 500° C. for 20 minutes in the oxygen atmosphere so as to be mainly baked. Electrical properties exhibited the leakage current value as large as 1.0×10⁻² A/cm², the dielectric loss of 0.001, and the relative permittivity of 100. It was also found that the BNO oxide layer has a fine crystal phase of the pyrochlore crystal structure.

### Comparative Example 2

A thin film capacitor according to the comparative example 2 was produced under conditions similar to those of the example 1 except that the precursor layer was heated to 500° C. for two hours in the oxygen atmosphere so as to be mainly baked. Electrical properties exhibited the leakage current value as large as 1.0×10⁻¹ A/cm², the dielectric loss of 0.007, and the relative permittivity of 180. It was also found that the BNO oxide layer has a fine crystal phase of the pyrochlore crystal structure. Furthermore, the carbon content percentage was 6.5 atm % and the hydrogen content percentage was 7.8 atm %, each of which had a large value.

### Comparative Example 3

A thin film capacitor according to the comparative example 3 was produced under conditions similar to those of the example 1 except that the precursor layer was heated to 600° C. for 20 minutes in the oxygen atmosphere so as to be mainly baked. Electrical properties exhibited the leakage current value of 7.0×10⁻⁶ A/cm², the dielectric loss of 0.001, and the relative permittivity of 80. It was possible to obtain, regarding the composition of a crystal phase of the BNO oxide layer, a crystal phase of the β-BiNbO₄ crystal structure.

### Comparative Example 4

A thin film capacitor according to the comparative example 4 was produced under conditions similar to those of the example 1 except that the precursor layer was heated to 650° C. for 20 minutes in the oxygen atmosphere so as to be mainly baked. Electrical properties exhibited the leakage current value of 5.0×10⁻³ A/cm², the dielectric loss of 0.001, and the relative permittivity of 95. It was possible to obtain, regarding the composition of a crystal phase of the BNO oxide layer, a crystal phase of the β-BiNbO₄ crystal structure.

### Comparative Example 5

In the comparative example 5, a BNO oxide layer serving as an insulating layer was formed on a lower electrode layer at a room temperature in accordance with the known sputtering technique, and was then heat treated at 550° C. for 20 minutes. A thin film capacitor was produced under conditions similar to those of the example 1, except for the above condition. Electrical properties exhibited the leakage current value of 1.0×10⁻⁷ A/cm², the dielectric loss of 0.005, and the relative permittivity of 50. It was possible to obtain, regarding the composition of a crystal phase of the BNO oxide layer, a fine crystal phase of the Bi₃NbO₇ crystal structure. Furthermore, the carbon content percentage was 1.5 atm % or less and the hydrogen content percentage was 1.0 atm % or less, each of which had a small value equal to or less than the detectable limit.

Tables 2 and 3 indicate the configuration of the thin film capacitor, the conditions for forming the oxide layer, the obtained electrical properties, the content percentages of carbon and hydrogen in the BNO oxide layer, and the result of the crystal structure in each of the examples 1 to 8 and the comparative examples 1 to 5. The “composition of crystal phases” in Tables 2 and 3 includes a crystal phase and a fine crystal phase. BiNbO₄ in Tables 2 and 3 indicates β-BiNbO₄.

The signs “-” in these tables are indicative of not being obtained because there was no need to obtain with consideration of other disclosed data.

TABLE 2

| Process conditions | | | | | | | | |
|---|---|---|---|---|---|---|---|---|
| and | Examples | | | | | | | |
| measurement results | 1 | 2 | 3 | 4 | 5 | 6 | 7 | 8 |
| Process | Solution | Solution | Solution | Solution | Solution | Solution | Solution | Solution |
| | technique | technique | technique | technique | technique | technique | technique | technique |
| Main baking | 520 | 520 | 530 | 530 | 550 | 550 | 550 | 580 |
| temperature | | | | | | | | |
| Main baking | 20 minutes | 1 hour | 20 minutes | 2 hours | 1 minute | 20 minutes | 12 hours | 20 minutes |
| time period | | | | | | | | |
| Electrode layer | Platinum | Platinum | Platinum layer | Platinum layer | Platinum layer | Platinum layer | Platinum layer | Platinum layer |
| | layer | layer | | | | | | |
| Dielectric loss | 0.025 | 0.01 | 0.01 | 0.018 | 0.01 | 0.001 | 0.004 | 0.001 |
| (1 KHz) | | | | | | | | |
| Leakage current | 3.0 × 10⁻⁴ | 3.0 × 10⁻⁸ | 3.0 × 10⁻⁶ | 8.8 × 10⁻⁸ | 5.0 × 10⁻⁷ | 1.0 × 10⁻⁶ | 2.0 × 10⁻⁵ | 1.0 × 10⁻⁶ |
| (A/cm²) | | | | | | | | |
| (0.25 MV/cm) | | | | | | | | |
| Relative permittivity | 62 | 70 | 110 | 170 | 100 | 180 | 100 | 100 |
| (1 KHz) | | | | | | | | |
| Carbon content | — | 1.5 or less | — | 1.5 or less | — | 1.5 or less | — | — |
| (atm %) | | | | | | | | |
| Hydrogen content | — | 1.6 | — | 1.4 | — | 1.0 or less | — | — |
| (atm %) | | | | | | | | |
| Composition of | BiNbO₄ | BiNbO₄ | BiNbO₄ | BiNbO₄ | BiNbO₄ | BiNbO₄ | BiNbO₄ | BiNbO₄ |
| crystal phases | Bi₂Nb₂O₇ | Bi₂Nb₂O₇ | Bi₂Nb₂O₇ | Bi₂Nb₂O₇ | Bi₂Nb₂O₇ | Bi₂Nb₂O₇ | Bi₂Nb₂O₇ | Bi₂Nb₂O₇ |

TABLE 3

| Process conditions | | | | | |
|---|---|---|---|---|---|
| and | Comparative Examples | | | | |
| measurement results | 1 | 2 | 3 | 4 | 5 |
| Process | Solution | Solution | Solution | Solution | Sputtering |
| | technique | technique | technique | technique | technique |
| Main baking | 500 | 500 | 600 | 650 | — |
| temperature | | | | | |
| Main baking | 20 minutes | 2 hours | 20 minutes | 20 minutes | — |
| time period | | | | | |
| Electrode | Platinum layer | Platinum layer | Platinum layer | Platinum layer | Platinum layer |
| layer | | | | | |
| Dielectric loss | 0.001 | 0.007 | 0.001 | 0.001 | 0.005 |
| (1 KHz) | | | | | |
| Leakage current (A/cm²) | 1.0 × 10⁻² | 1.0 × 10⁻¹ | 7.0 × 10⁻⁶ | 5.0 × 10⁻³ | 1.0 × 10⁻⁷ |
| (0.25 MV/cm) | | | | | |
| Relative permittivity | 100 | 180 | 80 | 95 | 50 |
| (1 KHz) | | | | | |
| Carbon content | — | 6.5 | — | — | 1.5 or less |
| (atm %) | | | | | |
| Hydrogen content | — | 7.8 | — | — | 1.0 or less |
| (atm %) | | | | | |
| Composition of | BiNbO₄Bi₂Nb₂O₇ | BiNbO₄Bi₂Nb₂O₇ | BiNbO₄ | BiNbO₄ | Bi₃NbO₇ |
| crystal phases | | | | | |

### 1. Electrical Properties

### (1) Relative Permittivity

As indicated in Tables 2 and 3, in each of the examples, the relative permittivity at 1 KHz was 60 or more and the thin film capacitor exhibited sufficient properties as a capacitor. Table 2 indicates the relative permittivity value of the entire oxide layer in each of the examples. As to be described later, the inventors of this application have analyzed to clarify that, even if this oxide layer includes a crystal phase other than the crystal phase of the pyrochlore crystal structure and the entire oxide layer thus has not very high relative permittivity, the crystal phase of the pyrochlore crystal structure is significantly higher in relative permittivity than a conventional crystal phase. The entire oxide film in each of the comparative example 3 or 4 achieved relative permittivity equivalent to those of the examples. However, the oxide film in each of the comparative example 3 or 4 does not have any crystal phase of the pyrochlore crystal structure, and there was accordingly found no point of locally high relative permittivity. Furthermore, the high heating temperature in each of the comparative example 3 or 4 leads to increase in production cost and is thus not preferred. The BNO layer having the Bi₃NbO₇ crystal structure in the comparative example 5 exhibited the relative permittivity as low as 50 entirely as well as locally.

### (2) Leakage Current

As indicated in Tables 2 and 3, in each of the examples, the leakage current value upon application of 0.25 MV/cm was 5.0×10⁻³ A/cm² or less and the thin film capacitor exhibited sufficient properties as a capacitor. Leakage current in each of the examples was sufficiently lower than that in the comparative example 1 or 2. Leakage current in the comparative example 3 or 4 was found to be equivalent to those in the examples. However, the comparative example 3 or 4 has a high heating temperature and thus leads to increase in production cost.

It was found that a preferred value was obtained when the heating temperature for formation of the oxide layer was set to 520° C. or more and less than 600° C. (more preferably, 580° C. or less). Furthermore, the results obtained in each of the examples were equivalent to those of the BNO layer formed in accordance with the sputtering technique in the comparative example 5.

### (3) Dielectric Loss (tan δ)

As indicated in Tables 2 and 3, in each of the examples, the dielectric loss at 1 KHz was 0.03 or less and the thin film capacitor exhibited sufficient properties as a capacitor. The oxide layer according to each of the examples is formed by baking a precursor solution including both a precursor containing bismuth (Bi) and a precursor containing niobium (Nb) as solutes. An oxide layer formed in accordance with the solution technique is thus a preferred insulating layer also in view of small dielectric loss. The oxide layer formed in accordance with the solution technique in each of the examples is regarded as having dielectric loss equivalent to that of the BNO layer formed in accordance with the sputtering technique in the comparative example 5.

### 2. Content Percentages of Carbon and Hydrogen in BNO Oxide Layer

Content percentages of carbon and hydrogen were obtained in the examples 2, 4, and 6 each having a main baking temperature in the range from 520° C. or more to less than 600° C. The BNO oxide layer was found to have a highly preferred carbon content percentage of 1.5 atm % or less in each of these examples. The carbon content percentage obtained in accordance with this measurement technique has a lower limit measurement value of about 1.5 atm %, so that the actual concentration is assumed to be equal to or less than the lower limit measurement value. It was also found that the carbon content percentage in each of these examples was at a level similar to that of the BNO oxide layer formed in accordance with the sputtering technique in the comparative example 5. When the main baking temperature is as low as 500° C. as in the comparative example 2, carbon in the solvent and the solute in the precursor solution is assumed to remain. The carbon content percentage had the value as large as 6.5 atm %. It is regarded that the leakage current thus had the value as large as 1.0×10⁻¹ A/cm².

In each of the examples 2, 4, and 6 having the main baking temperature in the range from 520° C. or more to less than 600° C., the BNO oxide layer had a preferred hydrogen content percentage of 1.6 atm % or less. The hydrogen content percentage obtained in accordance with this measurement technique has a lower limit measurement value of about 1.0 atm %, so that the actual concentration in the example 6 is assumed to be equal to or less than the lower limit measurement value. It was also found that the hydrogen content percentage in the example 6 was at a level similar to that of the BNO oxide layer formed in accordance with the sputtering technique in the comparative example 5. When the main baking temperature is as low as 500° C. as in the comparative example 2, hydrogen in the solvent and the solute in the precursor solution is assumed to remain. The hydrogen content percentage had the value as large as 7.8 atm %. Such a large hydrogen content percentage is also regarded as causing the leakage current to have the value as large as 1.0×10⁻¹ A/cm².

### 3. Crystal Structure Analysis by Cross-Sectional TEM Picture and Electron Beam Diffraction

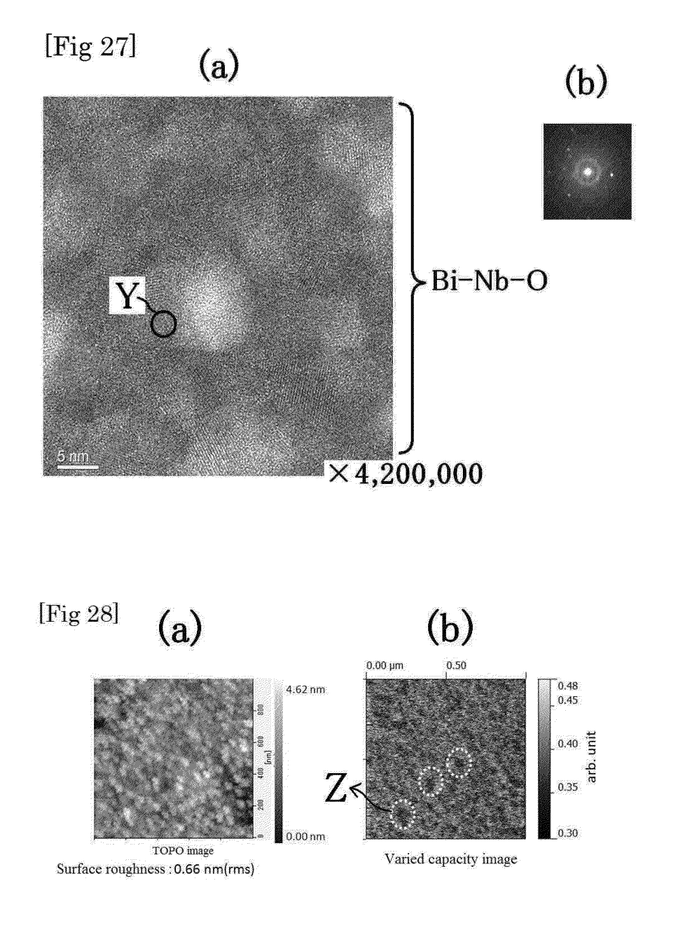

FIGS. 26(a) and 26(b) are a cross-sectional TEM picture and an electron beam diffraction image each showing the crystal structure of the BNO oxide layer according to the example 6. FIG. 26(a) is the cross-sectional TEM picture of the BNO oxide layer according to the example 6. FIG. 26(b) is the electron beam diffraction image of a region X in the cross-sectional TEM picture of the BNO oxide layer shown in FIG. 26(a). FIGS. 27(a) and 27(b) are a cross-sectional TEM picture and an electron beam diffraction image each showing a crystal structure of an oxide layer serving as an insulating layer in the comparative example 5 (the sputtering technique). FIG. 27(a) is the cross-sectional TEM picture showing the crystal structure of the BNO oxide layer according to the comparative example 5. FIG. 27(b) is the electron beam diffraction image of a region Y in the cross-sectional TEM picture of the BNO oxide layer shown in FIG. 27(a).

From the cross-sectional TEM picture and the electron beam diffraction image shown in FIGS. 26(a) and 26(b), it was found that the BNO oxide layer according to the present example includes a crystal phase and an amorphous phase. More particularly, the BNO oxide layer was found to include a crystal phase, a fine crystal phase, and an amorphous phase. The “fine crystal phase” in this application means a crystal phase that is not uniformly grown from the upper end to the lower end in the thickness direction of a layered material. Furthermore, fitting with a known crystal structure model in accordance with a Miller index and an interatomic distance indicated that the BNO oxide layer had at least one of a fine crystal phase of the pyrochlore crystal structure expressed by a general formula of A₂B₂O₇ (where A is a metal element and B is a transition metal element; this applies hereinafter) and a crystal phase of the triclinic β-BiNbO₄ crystal structure.

The fine crystal phase of the pyrochlore crystal structure is found to have different appearance depending on the main baking temperature for the precursor layer of the oxide layer serving as an insulating layer. As in the comparative examples 3 and 4, it was found that a crystal phase only of the β-BiNbO₄ crystal structure appears if the main baking temperature is 600° C. and 650° C.

In contrast, as in the examples 1 to 8, it was interestingly found that a fine crystal phase of the pyrochlore crystal structure appears if the main baking temperature is 520° C., 530° C., 550° C., and 580° C. More specifically, the pyrochlore crystal structure was found to be either the (Bi_{1.5}Zn_{0.5})(Zn_{0.5}Nb_{1.5})O₇ structure or substantially identical with or approximate to the (Bi_{1.5}Zn_{0.5})(Zn_{0.5}Nb_{1.5})O₇ structure.

The already known pyrochlore crystal structure is possibly obtained by including “zinc” as described above, but each of the examples had a result different from that according to the known aspect. It has not yet been clarified at the present stage why such a pyrochlore crystal structure appears in the composition not including zinc as in the examples. As to be described later, it was found that provision of a crystal phase of the pyrochlore crystal structure leads to preferred dielectric properties (high relative permittivity in particular) as an insulating layer of a thin film capacitor.

As in the examples 1 to 8, it was also found that an oxide layer serving as an insulating layer and having a crystal phase of the pyrochlore crystal structure exhibits preferred electrical properties as an insulating layer of a solid-state electronic device.

In contrast, neither a fine crystal phase of the pyrochlore crystal structure nor a crystal phase of the β-BiNbO₄ crystal structure was found in the oxide layer formed in accordance with the sputtering technique in the comparative example 5. Instead, a fine crystal phase of the Bi₃NbO₇ crystal structure was found in the comparative example 5.

### 4. Distribution Analysis of Crystal Phases Having Different Permittivity

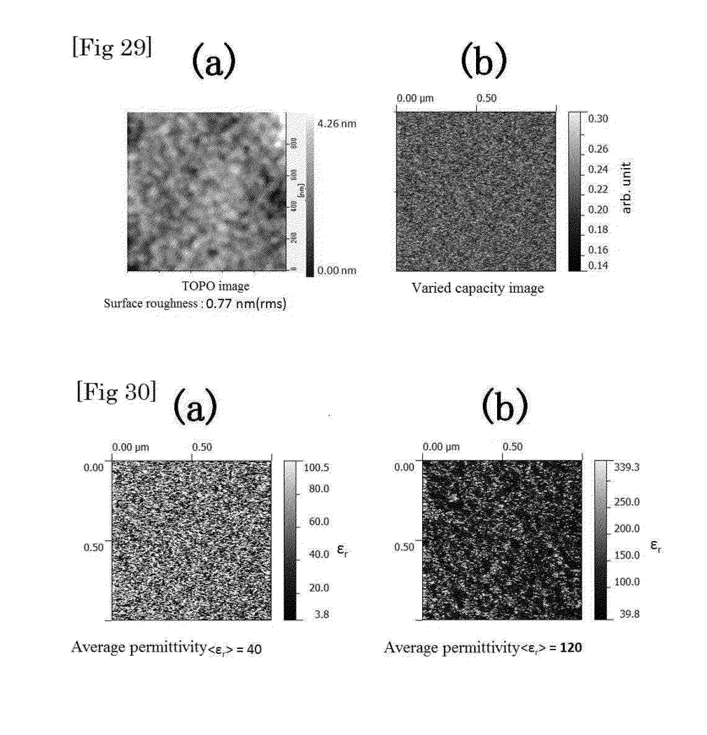

FIGS. 28(a) and 28(b) are a TOPO image (by a scanning probe microscope (in a supersensitive SNDM mode)) and a varied capacity image of each crystal phase in a plan view, of the BNO oxide layer in the representing example 6. FIGS. 29(a) and 29(b) are a TOPO image and a varied capacity image of each crystal phase in a plan view, of the oxide layer serving as an insulating layer in the representing comparative example 5 (the sputtering technique). FIGS. 30(a) and 30(b) are relative permittivity images indicating distribution of calibrated relative permittivity from varied capacity images of each crystal phase in a plan view of the oxide layer serving as an insulating layer in the comparative example 5 (the sputtering technique) and the oxide layer serving as an insulating layer in the example 6.

The TOPO images and the varied capacity images were obtained in the supersensitive SNDM mode by the scanning probe microscope (manufactured by SII Nanotechnology Inc.). The relative permittivity images indicating distribution of relative permittivity in FIGS. 30(a) and 30(b) are obtained by converting the varied capacity images in FIGS. 28(b) and 29(b) through formation of calibrated curves.

As indicated in FIGS. 28(a) to 30(b), the oxide layers mentioned above do not have large differences in surface roughness, while the BNO oxide layer in the example 6 was found to have a relative permittivity (Er) value much higher than a relative permittivity value of the BNO oxide layer in the comparative example 5. The TOPO image and the varied capacity image of the BNO oxide layer in the example 6 obviously have more significant tone distribution in comparison to those in the comparative example 5. It was found, by comparison with the uniform surface state of the BNO oxide layer formed in accordance with the sputtering technique, that the BNO oxide layer in the example 6 includes various crystal phases.

Found through further detailed analysis was that the BNO oxide layer in the example 6 includes a crystal phase of the pyrochlore crystal structure having relative permittivity much higher than that of any other crystal phase, a crystal phase of the β-BiNbO₄ crystal structure indicated in a region Z (darker region) in FIG. 28(b), and an amorphous phase. As shown in FIGS. 28(a), 28(b), 30(a), and 30(b), it was also found that the crystal phases of the pyrochlore crystal structure are distributed in particle or island shapes in the BNO oxide layer in a plan view in the example 6. The relative permittivity (Er) values indicated in FIGS. 30(a) and 30(b) are representative values in partially observed areas, and are thus slightly different from the values indicated in Table 2 or 3.

The inventors of this application have reached the conclusion, through analysis and study, that, in view of that the known crystal phase of the pyrochlore crystal structure possibly formed by inclusion of “zinc” has a comparatively high relative permittivity value, provision of the crystal phase of the pyrochlore crystal structure achieves exertion of high relative permittivity. Accordingly, even if the oxide layer includes a crystal phase other than the crystal phase of the pyrochlore crystal structure and the entire oxide layer has not very high relative permittivity, the oxide layer consisting of bismuth (Bi) and niobium (Nb) and having the crystal phase of the pyrochlore crystal structure thus improves electrical properties of various solid-state electronic devices. It is noted that this interesting extraordinary feature achieves the dielectric properties that have never been obtained. Similar phenomena are seen in the respective examples other than the example 6.

As described above, the fine crystal phases of the pyrochlore crystal structure are distributed in the oxide layer according to each of the embodiments. The oxide layer was thus found to have relative permittivity extraordinarily higher as a BNO oxide layer than that of a conventional oxide layer. The oxide layer according to each of the embodiments is produced in accordance with the solution technique, to achieve simplification in production process. Furthermore, when the oxide layer is formed at the heating temperature (main baking temperature) in the range from 520° C. or more to less than 600° C. (more preferably, 580° C. or less) in the production of the oxide layer in accordance with the solution technique, the BNO oxide layer thus obtained has preferred electrical properties of high relative permittivity as well as small dielectric loss. Moreover, the method of producing the oxide layer according to each of the above embodiments is simple and takes relatively short time with no need for complex and expensive equipment such as a vacuum system. These features remarkably contribute to provision of the oxide layer and various solid-state electronic devices including the oxide layer from the industrial or mass productivity perspectives.

### Other Embodiments

The oxide layer according to each of the above embodiments is appropriate for various solid-state electronic devices configured to control large current with low drive voltage. The solid-state electronic device including the oxide layer according to each of the above embodiments is applicable to a large number of devices in addition to the thin film capacitor. The oxide layer according to each of the embodiments is applicable to a capacitor such as a stacked thin film capacitor or a variable capacity thin film capacitor, a metal oxide semiconductor junction field effect transistor (MOSFET), a semiconductor device such as a nonvolatile memory, a micro total analysis system (TAS), a device of a microelectromechanical system represented by a microelectromechanical system (MEMS) such as a micro chemical chip or a DNA chip, or a nanoelectromechanical system (NEMS).

As described above, the above embodiments have been disclosed not for limiting the present invention but for describing these embodiments. Furthermore, modification examples made within the scope of the present invention, inclusive of other combinations of the embodiments, will be also included in the scope of the patent claims.

### DESCRIPTION OF REFERENCE SIGNS

10 Substrate
20,220,320.420 Lower electrode layer
220a,320a,420a Lower electrode layer precursor layer
30,230,330.430 Oxide layer
30a,230a,330a.430a Oxide layer precursor layer
40,240,340.440 Upper electrode layer
240a,340a,440a Upper electrode layer precursor layer
100,200,300,400 Thin film capacitor exemplifying solid-state electronic device
M1 Lower electrode layer mold
M2 Insulating layer mold
M3 Upper electrode layer mold
M4 Stacked body mold

1. An oxide layer comprising:
bismuth (Bi) and niobium (Nb) (possibly including inevitable impurities); wherein:
the oxide layer includes crystal phases of a pyrochlore crystal structure.

2. The oxide layer according to claim 1, wherein
the crystal phases of the pyrochlore crystal structure are distributed in particle or island shapes in the oxide layer in a plan view.

3. The oxide layer according to claim 1, wherein
the pyrochlore crystal structure is identical or substantially identical with (Bi_{1.5}Zn_{0.5})(Zn_{0.5}Nb_{1.5})O₇.

4. The oxide layer according to claim 1, wherein:
the oxide layer further includes an amorphous phase.

5. The oxide layer according to claim 1, wherein
the oxide layer has a carbon content percentage of 1.5 atm % or less.

6. A capacitor comprising:
the oxide layer according to claim 1.

7. A semiconductor device comprising:
the oxide layer according to claim 1.

8. A microelectromechanical system comprising:
the oxide layer according to claim 1.

9. A method of producing an oxide layer, the method comprising the step of:
heating, in an atmosphere containing oxygen, a precursor layer obtained from a precursor solution as a start material including both a precursor containing bismuth (Bi) and a precursor containing niobium (Nb) as solutes, at a temperature of 520° C. or more and less than 600° C., to form the oxide layer including crystal phases of a pyrochlore crystal structure and consisting of bismuth (Bi) and niobium (Nb) (possibly including inevitable impurities).

10. The method of producing the oxide layer according to claim 9, wherein
the crystal phases of the pyrochlore crystal structure are distributed in particle or island shapes in the oxide layer in a plan view in the step of forming the oxide layer.

11. The method of producing the oxide layer according to claim 9, wherein
the precursor layer is provided with an imprinted structure by imprinting the precursor layer that is heated at a temperature of 80° C. or more and 300° C. or less in an atmosphere containing oxygen before the oxide layer is formed.

12. The method of producing the oxide layer according to claim 9, wherein
the imprinting is performed with a pressure in a range from 1 MPa or more to 20 MPa or less.

13. The method of producing the oxide layer according to claim 9, wherein
the imprinting is performed using a mold that is preliminarily heated to a temperature in a range from 80° C. or more to 300° C. or less.
